(19) United States
(12) Patent Application Publication
(10) Pub. No.: US 2004/0138936 A1
(43) Pub. Date: Jul. 15, 2004

(54) Performing what-if forecasts using a business information and decisioning control system

(76) Inventors: Christopher D. Johnson, Clifton Park, NY (US); Brian N. Dingman, Gloversville, NY (US); Peter A. Kalish, Clifton Park, NY (US); Mousumi G. Kapoor, Haryana (IN); Shaji S. Menon, Karnataka (IN)

Correspondence Address: LEE & HAYES PLLC, SUITE 500, 421 W RIVERSIDE, SPOKANE, WA, 99201

(21) Appl. No.: 10/418,928

(22) Filed: Apr. 18, 2003

Related U.S. Application Data
(63) Continuation-in-part of application No. 10/339,166, filed on Jan. 9, 2003.

(51) Int. Cl. G06F 17/60

(52) U.S. Cl. 705/7

(57) ABSTRACT

A method is described for performing and acting on what-if forecasts in a business that includes multiple interrelated business processes. The method includes: (a) providing a business information and decisioning control system to a user, where the business information and decisioning control system includes a business system user interface that includes plural input mechanisms; (b) receiving the user's selection of an input setting made using at least one of the plural input mechanisms, the input setting defining a what-if case scenario; (c) performing a forecast based on the what-if case scenario to generate an output result, the output result forecasting an effect that the what-if case scenario will have on the interrelated business processes; (d) presenting the output result to the user; and (e) receiving the user's selection of a command via the business system user interface, where the command prompts at least one of the interrelated business processes to make a change representative of the input setting.

This application is a continuation-in-part of U.S. patent application Ser. No. 10/339,166, filed on Jan. 9, 2003, entitled “Digital Cockpit,” which is incorporated by reference herein in its entirety.

### TECHNICAL FIELD

This invention relates to providing business-related analysis, and, in a more particular implementation, to an automated technique for providing business-related forecasts.

### BACKGROUND

A variety of automated techniques exist for making business forecasts, including various business simulation techniques. However, these techniques are often applied in an unstructured manner. For instance, a business analyst may have a vague notion that computer-automated forecasting tools might be of use in predicting certain aspects of business performance. In this case, the business analyst proceeds by selecting a particular forecasting tool, determining the data input requirements of the selected tool, manually collecting the required data from the business, and then performing a forecast using the tool to generate an output result. The business analyst then determines whether the output result warrants making changes to the business. If so, the business analyst attempts to determine what aspects of the business should be changed, and then proceeds to modify these aspects in manual fashion, e.g., by manually accessing and modifying a resource used by the business. If the result of these changes does not produce a satisfactory result, the business analyst may decide to make further corrective changes to the business.

The above-described ad hoc approach has many drawbacks. For instance, this approach is essentially reactive in nature. A certain change in the business may introduce a new problem within the business, which requires further corrective action, and so on. This may result in the business analyst making a series of potentially disruptive changes to the business that may yield unanticipated responses. This may have the net effect of sending the business along an inefficient and erratic path, thus potentially degrading system level value and risk profiles associated with business performance.

A business analyst can run another business simulation upon discovering that a previous business simulation yielded unsatisfactory results when applied to the business. However, current simulation technology does not enable the business analyst to apply a structured approach for running alternative simulation scenarios for a complex business environment that includes multiple business processes. For instance, the complexity of such a business may obscure the factors that are responsible for a business failing to perform as intended when a business analyst makes an initial change to the business. Thus, even though the business analyst has the ability to run or rerun a business simulation scenario with a different set of assumptions, the analyst may lack an understanding of what assumptions to change, or may lose track of what assumptions have been tried in the past (along with the supporting data used in processing the past assumptions). In any event, the above-described ad-hoc approach to changing the business does not provide any assurance that the business analyst has provided an optimum selection of control settings used to control the business. Further, even if the business analyst does provide a satisfactory result, there is no provision for extracting any meaningful insight from this success to enable the results to be duplicated in subsequent efforts to control the business.

Accordingly, there is an exemplary need in the art for a more efficient and reliable technique for making forecasts in a business environment, particularly within a business environment that includes multiple interrelated business processes.

### SUMMARY

According to one exemplary implementation, a method is described for performing and acting on what-if forecasts in a business that includes multiple interrelated business processes. The method includes: (a) providing a business information and decisioning control system to a user, where the business information and decisioning control system includes a business system user interface that includes plural input mechanisms; (b) receiving the user's selection of an input setting made using at least one of the plural input mechanisms, the input setting defining a what-if case scenario; (c) performing a forecast based on the what-if case scenario to generate an output result, the output result forecasting an effect that the what-if case scenario will have on the interrelated business processes; (d) presenting the output result to the user; and (e) receiving the user's selection of a command via the business system user interface, where the command prompts at least one of the interrelated business processes to make a change representative of the input setting.

Related method of use, system, and interface implementations are also described.

### BRIEF DESCRIPTION OF THE DRAWINGS

FIG. 1 shows an exemplary high-level view of an environment in which a business is using a “digital cockpit” to steer it in a desired direction.

FIG. 2 shows an exemplary system for implementing the digital cockpit shown in FIG. 1.

FIG. 3 shows an exemplary cockpit interface.

FIG. 4 shows an exemplary method for using the digital cockpit.

FIG. 5 shows an exemplary application of what-if analysis to the calculation of a throughput cycle time or “span” time in a business process.

FIG. 6 shows the use of automated optimizing and decisioning to identify a subset of viable what-if cases.

FIG. 7 shows an exemplary depiction of the digital cockpit, analogized as an operational amplifier.

FIG. 8 shows an exemplary application of the digital cockpit to a business system that provides financial services.

FIG. 9 shows an exemplary response surface for a model having a portion that is relatively flat and a portion that changes dramatically.

FIG. 10 shows an exemplary method for generating model output results before the user requests these results.

FIG. 11 shows a vehicle traveling down a roadway, where this figure is used to demonstrate an analogy between the field of view provided to the operator of the vehicle and the “field of view” provided to a digital cockpit user.

FIG. 12 shows a two dimensional graph showing a calculated output value verses time, with associated confidence information conveyed using confidence bands.

FIG. 13 shows a three dimension graph showing a calculated output value verses time, with associated confidence information conveyed using confidence bands.

FIG. 14 shows the presentation of confidence information using changes in perspective.

FIG. 15 shows the presentation of confidence information using changes in fading level.

FIG. 16 shows the presentation of confidence information using changes in an overlaying field that obscures the output result provided by a model.

FIG. 17 shows the presentation of confidence information using graphical probability distributions.

FIG. 18 shows the presentation of an output result where a change in a variable other than time is presented on the z-axis.

FIG. 19 shows a method for visualizing the output result of a model and associated confidence information.

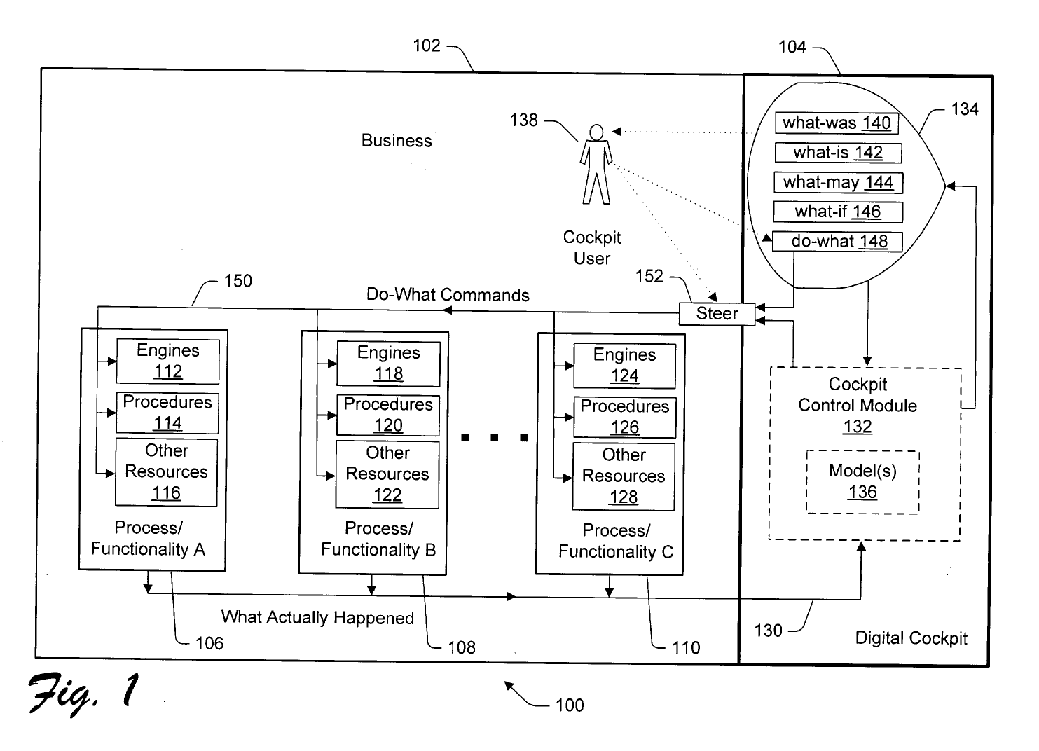

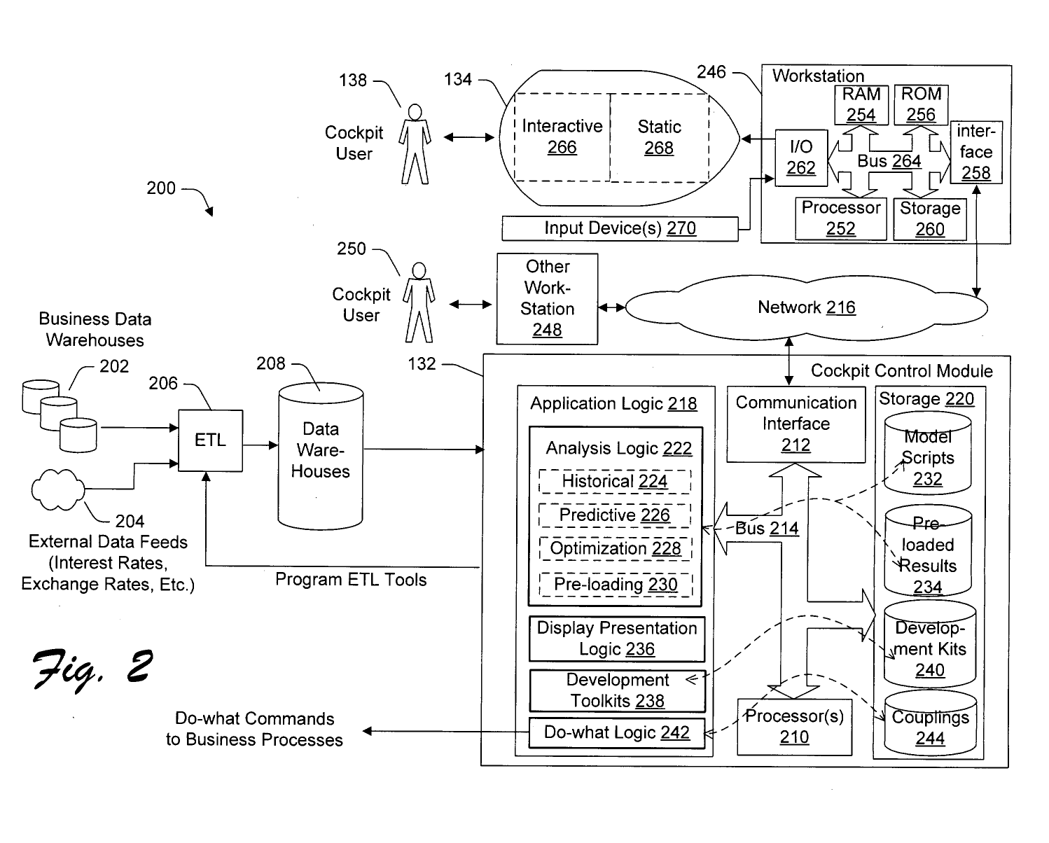

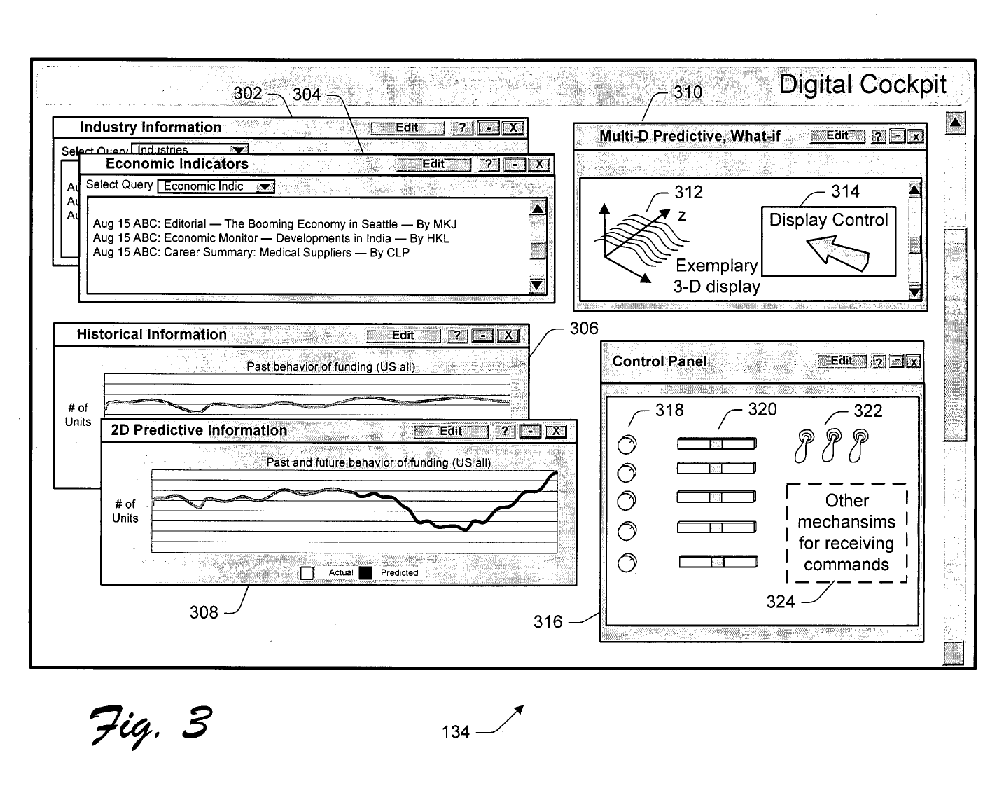

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

An information and decisioning control system that provides business forecasts is described herein. The system is used to control a business that includes multiple interrelated processes. The term “business” has broad connotation. A business may refer to a conventional enterprise for providing goods or services for profit (or to achieve some other business-related performance metric). The business may include a single entity, or a conglomerate entity comprising several different business groups or companies. Further, a business may include a chain of businesses formally or informally coupled through market forces to create economic value. The term “business” may also loosely refer to any organization, such as any non-profit organization, an academic organization, governmental organization, etc.

Generally, the terms “forecast” and “prediction” are also used broadly in this disclosure. These terms encompass any kind of projection of “what may happen” given any kind of input assumptions. In one case, a user may generate a prediction by formulating a forecast based on the course of the business thus far in time. Here, the input assumption is defined by the actual course of the business. In another case, a user may generate a forecast by inputting a set of assumptions that could be present in the business (but which do not necessarily reflect the current state of the business), which prompts the system to generate a forecast of what may happen if these assumptions are realized. Here, the forecast assumes more of a hypothetical (“what if”) character (e.g., “If X is put into place, then Y is likely to happen”).

To facilitate explanation, the business information and decisioning control system is referred to in the ensuing discussion by the descriptive phrase “digital cockpit.” A business intelligence interface of the digital cockpit will be referenced to as a “cockpit interface.”

The disclosure contains the following sections:

A. Overview of a Digital Cockpit with Predictive Capability

B. What-if Functionality

C. Do-What Functionality

D. Pre-loading of Results

E. Visualization Functionality

F. Conclusion

A. Overview of a Digital Cockpit with Predictive Capability (with reference to FIGS. 1-4).

FIG. 1 shows a high-level view of an environment 100 in which a business 102 is using a digital cockpit 104 to steer it in a desired direction. The business 102 is generically shown as including an interrelated series of processes (106, 108, . . . 110). The processes (106, 108, . . . 110) respectively perform allocated functions within the business 102. That is, each of the processes (106, 108, . . . 110) receive one or more input items, perform processing on the input items, and then output the processed items. For instance, in a manufacturing environment, the processes (106, 108, . . . 110) may represent different stages in an assembly line for transforming raw material into a final product. Other exemplary processes in the manufacturing environment can include shop scheduling, machining, design work, etc. In a finance-related business 102, the processes (106, 108, . . . 110) may represent different processing steps used in transforming a business lead into a finalized transaction that confers some value to the business 102. Other exemplary processes in this environment can include pricing, underwriting, asset management, etc. Many other arrangements are possible. As such, the input and output items fed into and out of the processes (106, 108, . . . 110) can represent a wide variety of “goods,” including human resources, information, capital, physical material, and so on. In general, the business processes (106, 108, . . . 110) may exist within a single business entity 102. Alternatively, one or more of the processes (106, 108, . . . 110) can extend to other entities, markets, and value chains (such as suppliers, distribution conduits, commercial conduits, associations, and providers of relevant information).

More specifically, each of the processes (106, 108, . . . 110) can include a collection of resources. The term “resources” as used herein has broad connotation and can include any aspect of the process that allows it to transform input items into output items. For instance, process 106 may draw from one or more engines 112. An “engine” 112 refers to any type of tool used by the process 106 in performing the allocated function of the process 106. In the context of a manufacturing environment, an engine 112 might refer to a machine for transforming materials from an initial state to a processed state. In the context of a finance-related environment, an engine 112 might refer to a technique for transforming input information into processed output information. For instance, in one finance-related application, an engine 112 may include one or more equations for transforming input information into output information. In other applications, an engine 112 may include various statistical techniques, rule-based techniques, artificial intelligence techniques, etc. The behavior of these engines 112 can be described using transfer functions. A transfer function translates at least one input into at least one output using a translation function. The translation function can be implemented using a mathematical model or other form of mapping strategy.

A subset of the engines 112 can be used to generate decisions at decision points within a business flow. These engines are referred to as “decision engines.” The decision engines can be implemented using manual analysis performed by human analysts, automated analysis performed by automated computerized routines, or a combination of manual and automated analysis.

Other resources in the process 106 include various procedures 114. In one implementation, the procedures 114 represent general protocols followed by the business in transforming input items into output items. In another implementation, the procedures 114 can reflect automated protocols for performing this transformation.

The process 106 may also generically include “other resources” 116. Such other resources 116 can include any feature of the process 106 that has a role in carrying out the function(s) of the process 106. An exemplary “other resource” may include staffing resources. Staffing resources refer to the personnel used by the business 102 to perform the functions associated with the process 106. For instance, in a manufacturing environment, the staffing resources might refer to the workers required to run the machines within the process. In a finance-related environment, the staffing resources might refer to personnel required to perform various tasks involved in transforming information or “financial products” (e.g., contracts) from an initial state to a final processed state. Such individuals may include salesman, accountants, actuaries, etc. Still other resources can include various control platforms (such as Supply Chain, Enterprise Resource Planning, Manufacturing-Requisitioning and Planning platforms, etc.), technical infrastructure, etc.

In like fashion, process 108 includes one or more engines 118, procedures 120, and other resources 122. Process 110 includes one or more engines 124, procedures 126, and other resources 128. Although the business 102 is shown as including three processes (106, 108, . . . 110), this is merely exemplary; depending on the particular business environment, more than three processes can be included, or less than three processes can be included.

The digital cockpit 104 collects information received from the processes (106, 108, . . . 110) via communication path 130, and then processes this information. Such communication path 130 may represent a digital network communication path, such as the Internet, an Intranet network within the business enterprise 102, a LAN network, etc.

The digital cockpit 104 itself includes a cockpit control module 132 coupled to a cockpit interface 134. The cockpit control module 132 includes one or more models 136. A model 136 transforms information collected by the processes (106, 108, . . . 110) into an output using a transfer function or plural transfer functions. As explained above, the transfer function of a model 136 maps one or more independent variables (e.g., one or more X variables) into one or more dependent variables (e.g., one or more Y variables). For example, a model 136 that employs a transfer function can map one or more X variables that pertain to historical information collected from the processes (106, 108, . . . 110) into one or more Y variables that deterministically and/or probabilistically forecast what is likely to happen in the future. Such models 136 may use, for example, discrete event simulations, continuous simulations, Monte Carlo simulations, regressive analysis techniques, time series analyses, artificial intelligence analyses, extrapolation and logic analyses, etc.

Other functionality provided by the cockpit control module 132 can perform data collection tasks. Such functionality specifies the manner in which information is to be extracted from one or more information sources and subsequently transformed into a desired form. The information can be transformed by algorithmically processing the information using one or more models 136, or by manipulating the information using other techniques. More specifically, such functionality is generally implemented using so-called Extract-Transform-Load tools (i.e., ETL tools).

A subset of the models 136 in the cockpit control module 132 may be the same as some of the models embedded in engines (112, 118, 124) used in respective processes (106, 108, . . . 110). In this case, the same transfer functions used in the cockpit control module 132 can be used in the day-to-day business operations within the processes (106, 108, . . . 110). Other models 136 used in the cockpit control module 132 are exclusive to the digital cockpit 104 (e.g., having no counterparts within the processes themselves (106, 108, . . . 110)). In the case where the cockpit control module 132 uses the same models 136 as one of the processes (106, 108, . . . 110), it is possible to store and utilize a single rendition of these models 136, or redundant copies or versions of these models 136 can be stored in both the cockpit control module 132 and the processes (106, 108, . . . 110).

A cockpit user 138 interacts with the digital cockpit 104 via the cockpit interface 134. The cockpit user 138 can include any individual within the business 102 (or potentially outside the business 102). The cockpit user 138 frequently will have a decision-maker role within the organization, such as chief executive officer, risk assessment analyst, general manager, an individual intimately familiar with one or more business processes (e.g., a business “process owner”), and so on.

The cockpit interface 134 presents various fields of information regarding the course of the business 102 to the cockpit user 138 based on the outputs provided by the models 136. For instance, the cockpit interface 134 may include a field 140 for presenting information regarding the past course of the business 102 (referred to as a “what has happened” field, or a “what-was” field for brevity). The cockpit interface 134 may include another field 142 for presenting information regarding the present state of the business 102 (referred to as “what is happening” field, or a “what-is” field for brevity). The cockpit interface 134 may also include another field 144 for presenting information regarding the projected future course of the business 102 (referred to as a “what may happen” field, or “what-may” field for brevity).

In addition, the cockpit interface 134 presents another field 146 for receiving hypothetical case assumptions from the cockpit user 138 (referred to as a “what-if” field). More specifically, the what-if field 146 allows the cockpit user 138 to enter information into the cockpit interface 134 regarding hypothetical or actual conditions within the business 102. The digital cockpit 104 will then compute various consequences of the identified conditions within the business 102 and present the results to the cockpit user 138 for viewing in the what-if display field 146.

After analyzing information presented by fields 140, 142, 144, and 146, the cockpit user 138 may be prepared to take some action within the business 102 to steer the business 102 in a desired direction based on some objective in mind (e.g., to increase revenue, increase sales volume, improve processing timeliness, etc.). To this end, the cockpit interface 134 includes another field (or fields) 148 for allowing the cockpit user 138 to enter commands that specify what the business 102 is to do in response to information (referred to as “do-what” commands for brevity). More specifically, the do-what field 148 can include an assortment of interface input mechanisms (not shown), such as various graphical knobs, sliding bars, text entry fields, etc. (In addition, or in the alternative, the input mechanisms can include other kinds of input devices, such as voice recognition devices, motion detection devices, various kinds of biometric input devices, various kinds of biofeedback input devices, and so on.) The business 102 includes a communication path 150 for forwarding instructions generated by the do-what commands to the processes (106, 108, . . . 110). Such communication path 150 can be implemented as a digital network communication path, such as the Internet, an intranet within a business enterprise 102, a LAN network, etc. In one implementation, the communication path 130 and communication path 150 can be implemented as the same digital network.

The do-what commands can affect a variety of changes within the processes (106, 108, . . . 110) depending on the particular business environment in which the digital cockpit 104 is employed. In one case, the do-what commands affect a change in the engines (112, 118, 124) used in the respective processes (106, 108, . . . 110). Such modifications may include changing parameters used by the engines (112, 118, 124), changing the strategies used by the engines (112, 118, 124), changing the input data fed to the engines (112, 118, 124), or changing any other aspect of the engines (112, 118, 124). In another case, the do-what commands affect a change in the procedures (114, 120, 126) used by the respective processes (106, 108, 110). Such modifications may include changing the number of workers assigned to specific tasks within the processes (106, 108, . . . 110), changing the amount of time spent by the workers on specific tasks in the processes (106, 108, . . . 110), changing the nature of tasks assigned to the workers, or changing any other aspect of the procedures (114, 120, 126) used in the processes (106, 108, . . . 110). Finally, the do-what commands can generically make other changes to the other resources (116, 122, 128), depending on the context of the specific business application.

The business 102 provides other mechanisms for affecting changes in the processes (106, 108, . . . 110) besides the do-what field 148. Namely, in one implementation, the cockpit user 138 can directly make changes to the processes (106, 108, . . . 110) without transmitting instructions through the communication path 150 via the do-what field 148. In this case, the cockpit user 138 can directly visit and make changes to the engines (112, 118, 124) in the respective processes (106, 108, . . . 110). Alternatively, the cockpit user 138 can verbally instruct various staff personnel involved in the processes (106, 108, . . . 110) to make specified changes.

In still another case, the cockpit control module 132 can include functionality for automatically analyzing information received from the processes (106, 108, . . . 110), and then automatically generating do-what commands for dissemination to appropriate target resources within the processes (106, 108, . . . 110). As will be described in greater detail below, such automatic control can include mapping various input conditions to various instructions to be propagated into the processes (106, 108, . . . 110). Such automatic control of the business 102 can therefore be likened to an automatic pilot provided by a vehicle. In yet another implementation, the cockpit control module 132 generates a series of recommendations regarding different courses of actions that the cockpit user 138 might take, and the cockpit user 138 exercises human judgment in selecting a control strategy from among the recommendations (or in selecting a strategy that is not included in the recommendations).

A steering control interface 152 generally represents the cockpit user 138's ability to make changes to the business processes (106, 108, . . . 110), whether these changes are made via the do-what field 148 of the cockpit interface 134, via conventional and manual routes, or via automated process control. To continue with the metaphor of a physical cockpit, the steering control interface 152 generally represents a steering stick used in an airplane cockpit to steer the airplane, where such a steering stick may be controlled by the cockpit user by entering commands through a graphical user interface. Alternatively, the steering stick can be manually controlled by the user, or automatically controlled by an “auto-pilot.”

Whatever mechanism is used to affect changes within the business 102, such changes can also include modifications to the digital cockpit 104 itself. For instance, the cockpit user 138 can also make changes to the models 136 used in the cockpit control module 132. Such changes may comprise changing the parameters of a model 136, or entirely replacing one model 136 with another model 136, or supplementing the existing models 136 with additional models 136. Moreover, the use of the digital cockpit 104 may comprise an integral part of the operation of different business processes (106, 108, . . . 110). In this case, cockpit user 138 may want to change the models 136 in order to affect a change in the processes (106, 108, . . . 110).

In one implementation, the digital cockpit 104 receives information from the business 102 and forwards instructions to the business 102 in real time or near real time. That is, in this case, the digital cockpit 104 collects data from the business 102 in real time or near real time. Further, if configured to run in an automatic mode, the digital cockpit 104 automatically analyzes the collected data using one or more models 136 and then forwards instructions to processes (106, 108, . . . 110) in real time or near real time. In this manner, the digital cockpit 104 can translate changes that occur within the processes (106, 108, . . . 110) to appropriate corrective action transmitted to the processes (106, 108, . . . 110) in real time or near real time in a manner analogous to an auto-pilot of a moving vehicle. In the context used here, “near real time” generally refers to a time period that is sufficient timely to steer the business 102 along a desired path, without incurring significant deviations from this desired path. Accordingly, the term “near real time” will depend on the specific business environment in which the digital cockpit 104 is deployed; in one exemplary embodiment, “near real time” can refer to a delay of several seconds, several minutes, etc.

FIG. 2 shows an exemplary architecture 200 for implementing the functionality described in FIG. 1. The digital cockpit 104 receives information from a number of sources both within and external to the business 102. For instance, the digital cockpit 104 receives data from business data warehouses 202. These business data warehouses 202 store information collected from the business 102 in the normal course of business operations. In the context of the FIG. 1 depiction, the business data warehouses 202 can store information collected in the course of performing the tasks in processes (106, 108, . . . 110). Such business data warehouses 202 can be located together at one site, or distributed over multiple sites. The digital cockpit 104 also receives information from one or more external sources 204. Such external sources 204 may represent third party repositories of business information, such as enterprise resource planning sources, information obtained from partners in a supply chain, market reporting sources, etc.

An Extract-Transform-Load (ETL) module 206 extracts information from the business data warehouses 202 and the external sources 204, and performs various transformation operations on such information. The transformation operations can include: 1) performing quality assurance on the extracted data to ensure adherence to pre-defined guidelines, such as various expectations pertaining to the range of data, the validity of data, the internal consistency of data, etc; 2) performing data mapping and transformation, such as mapping identical fields that are defined differently in separate data sources, eliminating duplicates, validating cross-data source consistency, providing data convergence (such as merging records for the same customer from two different data sources), and performing data aggregation and summarization; 3) performing post-transformation quality assurance to ensure that the transformation process does not introduce errors, and to ensure that data convergence operations did not introduce anomalies, etc. The ETL module 206 also loads the collected and transformed data into a data warehouse 208. The ETL module 206 can include one or more selectable tools for performing its ascribed tasks, collectively forming an ETL toolset. For instance, the ETL toolset can include one of the tools provided by Informatica Corporation of Redwood City, Calif., and/or one of the tools provided by DataJunction Corporation of Austin, Tex. Still other tools can be used in the ETL toolset, including tools specifically tailored by the business 102 to perform unique in-house functions.

The data warehouse 208 may represent one or more storage devices. If multiple storage devices are used, these storage devices can be located in one central location or distributed over plural sites. Generally, the data warehouse 208 captures, scrubs, summarizes, and retains the transactional and historical detail necessary to monitor changing conditions and events within the business 102. Various known commercial products can be used to implement the data warehouse 208, such as various data storage solutions provided by the Oracle Corporation of Redwood Shores, Calif.

Although not shown in FIG. 2, the architecture 200 can include other kinds of storage devices and strategies. For instance, the architecture 200 can include an On-Line Analytical Processing (OLAP) server (not shown). An OLAP server provides an engine that is specifically tailored to perform data manipulation of multi-dimensional data structures. Such multi-dimensional data structures arrange data according to various informational categories (dimensions), such as time, geography, credit score, etc. The dimensions serve as indices for retrieving information from a multi-dimensional array of information, such as so-called OLAP cubes.

The architecture 200 can also include a digital cockpit data mart (not shown) that culls a specific set of information from the data warehouse 208 for use in performing a specific subset of tasks within the business enterprise 102. For instance, the information provided in the data warehouse 208 may serve as a global resource for the entire business enterprise 102. The information culled from this data warehouse 208 and stored in the data mart (not shown) may correspond to the specific needs of a particular group or sector within the business enterprise 102.

The information collected and stored in the above-described manner is fed into the cockpit control module 132. The cockpit control module 132 can be implemented as any kind of computer device, including one or more processors 210, various memory media (such as RAM, ROM, disc storage, etc.), a communication interface 212 for communicating with an external entity, a bus 214 for communicatively coupling system components together, as well as other computer architecture features that are known in the art. In one implementation, the cockpit control module 132 can be implemented as a computer server coupled to a network 216 via the communication interface 212. In this case, any kind of server platform can be used, such as server functionality provided by iPlanet, produced by Sun Microsystems, Inc., of Santa Clara, Calif. The network 216 can comprise any kind of communication network, such as the Internet, a business Intranet, a LAN network, an Ethernet connection, etc. The network 216 can be physically implemented as hardwired links, wireless links (e.g., radio frequency links), a combination of hardwired and wireless links, or some other architecture. It can use digital communication links, analog communication links, or a combination of digital and analog communication links.

The memory media within the cockpit control module 132 can be used to store application logic 218 and record storage 220. For instance, the application logic 218 can constitute different modules of program instructions stored in RAM memory. The record storage 220 can constitute different databases for storing different groups of records using appropriate data structures. More specifically, the application logic 218 includes analysis logic 222 for performing different kinds of analytical tasks. For example, the analysis logic 222 includes historical analysis logic 224 for processing and summarizing historical information collected from the business 102, and/or for presenting information pertaining to the current status of the business 102. The analysis logic 222 also includes predictive analysis logic 226 for generating business forecasts based on historical information collected from the business 102. Such predictions can take the form of extrapolating the past course of the business 102 into the future, and for generating error information indicating the degrees of confidence associated with its predictions. Such predictions can also take the form of generating predictions in response to an input what-if scenario. A what-if scenario refers to a hypothetical set of conditions (e.g., cases) that could be present in the business 102. Thus, the predictive logic 226 would generate a prediction that provides a forecast of what might happen if such conditions (e.g., cases) are realized through active manipulation of the business processes (106, 108, . . . 110).

The analysis logic 222 further includes optimization logic 228. The optimization logic 228 computes a collection of model results for different input case assumptions, and then selects a set of input case assumptions that provides preferred model results. More specifically, this task can be performed by methodically varying different variables defining the input case assumptions and comparing the model output with respect to a predefined goal (such as an optimized revenue value, or optimized sales volume, etc.). The case assumptions that provide the “best” model results with respect to the predefined goal are selected, and then these case assumptions can be actually applied to the business processes (106, 108, . . . 110) to realize the predicted “best” model results in actual business practice.

Further, the analysis logic 222 also includes pre-loading logic 230 for performing data analysis in off-line fashion. More specifically, processing cases using the models 136 may be time-intensive. Thus, a delay may be present when a user requests a particular analysis to be performed in real-time fashion. To reduce this delay, the pre-loading logic 230 performs analysis in advance of a user's request. As will be described in Section D of this disclosure, the pre-loading logic 230 can perform this task based on various considerations, such as an assessment of the variation in the response surface of the model 136, an assessment of the likelihood that a user will require specific analyses, etc.

The analysis logic 222 can include a number of other modules for performing analysis, although not specifically identified in FIG. 2. For instance, the analysis logic 222 can include logic for automatically selecting an appropriate model (or models) 136 to run based on the cockpit user's 138 current needs. For instance, empirical data can be stored which defines which models 136 have been useful in the past for successfully answering various queries specified by the cockpit user 138. This module can use this empirical data to automatically select an appropriate model 136 for use in addressing the cockpit user's 138 current needs (as reflected by the current query input by the cockpit user 138, as well as other information regarding the requested analysis). Alternatively, the cockpit user 138 can manually select one or more models 136 to address an input case scenario. In like fashion, when the digital cockpit 104 operates in its automatic mode, the analysis logic 222 can use automated or manual techniques to select models 136 to run.

The storage logic 220 can include a database 232 that stores various models scripts. Such models scripts provide instructions for running one or more analytical tools in the analysis logic 222. As used in this disclosure, a model 136 refers to an integration of the tools provided in the analysis logic 222 with the model scripts provided in the database 232. In general, such tools and scripts can execute regression analysis, time-series computations, cluster analysis, and other types of analyses. A variety of commercially available software products can be used to implement the above-described modeling tasks. To name but a small sample, the analysis logic 222 can use one or more of the family of Crystal Ball products produced by Decisioneering, Inc. of Denver Colo., one or more of the Mathematica products produced by Wolfram, Inc. of Champaign Ill., one or more of the SAS products produced by SAS Institute Inc. of Cary, N.C., etc. Such models 136 generally provide output results (e.g., one or more Y variables) based on input data (e.g., one or more X variables). Such X variables can represent different kinds of information depending on the configuration and intended use of the model 136. Generally, input data may represent data collected from the business 102 and stored in the database warehouses 208. Input data can also reflect input assumptions specified by the cockpit user 138, or automatically selected by the digital cockpit 104. An exemplary transfer function used by a model 136 can represent a mathematical equation or other function fitted to empirical data collected over a span of time. Alternatively, an exemplary transfer function can represent a mathematical equation or other function derived from “first principles” (e.g., based on a consideration of economic principles). Other exemplary transfer functions can be formed based on other considerations.

The storage logic 220 can also include a database 234 for storing the results pre-calculated by the pre-loading logic 230. As mentioned, the digital cockpit 104 can retrieve results from this database when the user requests these results, instead of calculating these results at the time of request. This reduces the time delay associated with the presentation of output results, and supports the overarching aim of the digital cockpit 104, which is to provide timely and accurate results to the cockpit user 138 when the cockpit user 138 needs such results. The database 234 can also store the results of previous analyses performed by the digital cockpit 104, so that if these results are requested again, the digital cockpit 104 need not recalculate these results.

The application logic 218 also includes other programs, such as display presentation logic 236. The display presentation logic 236 performs various tasks associated with displaying the output results of the analyses performed by the analysis logic 222. Such display presentation tasks can include presenting probability information that conveys the confidence associated with the output results using different display formats. The display presentation logic 236 can also include functionality for rotating and scaling a displayed response surface to allow the cockpit user 138 to view the response surface from different “vantage points,” to thereby gain better insight into the characteristics of the response surface. Section E of this disclosure provides additional information regarding exemplary functions performed by the display presentation logic 236.

The application logic 218 also includes development toolkits 238. A first kind of development toolkit 238 provides a guideline used to develop a digital cockpit 104 with predictive capabilities. More specifically, a business 102 can comprise several different affiliated companies, divisions, branches, etc. A digital cockpit 104 may be developed in for one part of the company, and thereafter tailored to suit other parts of the company. The first kind of development toolkit 238 provides a structured set of consideration that a development team should address when developing the digital cockpit 104 for other parts of the company (or potentially, for another unaffiliated company). The first kind of development toolkit 238 may specifically include logic for providing a general “roadmap” for developing the digital cockpit 104 using a series of structured stages, each stage including a series of well-defined action steps. Further, the first kind of development toolkit 238 may also provide logic for presenting a number of tools that are used in performing individual action steps within the roadmap. U.S. patent application Ser. No. ______ (Attorney Docket No. 85CI-00128), filed on the same day as the present application, and entitled, “Development of a Model for Integration into a Business Intelligence System,” provides additional information regarding the first kind of development toolkit 238. A second kind of development toolkit 238 can be used to derive the transfer functions used in the predictive digital cockpit 104. This second kind of development toolkit 238 can also include logic for providing a general roadmap for deriving the transfer functions, specifying a series of stages, where each stage includes a defined series of action steps, as well as a series of tools for use at different junctures in the roadmap. Record storage 220 includes a database 240 for storing information used in conjunction with the development toolkits 238, such as various roadmaps, tools, interface page layouts, etc.

Finally, the application logic 218 includes do-what logic 242. The do-what logic 242 includes the program logic used to develop and/or propagate instructions into the business 102 for affecting changes in the business 102. For instance, as described in connection with FIG. 1, such changes can constitute changes to engines (112, 118, 124) used in business processes (106, 108, . . . 110), changes to procedures (114, 120, 126) used in business processes (106, 108, . . . 110), or other changes. The do-what instructions propagated into the processes (106, 108, . . . 110) can also take the form of various alarms and notifications transmitted to appropriate personnel associated with the processes (106, 108, . . . 110) (e.g., transmitted via e-mail, or other communication technique).

In one implementation, the do-what logic 242 is used to receive do-what commands entered by the cockpit user 138 via the cockpit interface 134. Such cockpit interface 134 can include various graphical knobs, slide bars, switches, etc. for receiving the user's commands. In another implementation, the do-what logic 242 is used to automatically generate the do-what commands in response to an analysis of data received from the business processes (106, 108, . . . 110). In either case, the do-what logic 242 can rely on a coupling database 244 in developing specific instructions for propagation throughout the business 102. For instance, the do-what logic 242 in conjunction with the database 244 can map various entered do-what commands into corresponding instructions for affecting specific changes in the resources of business processes (106, 108, . . . 110). This mapping can rely on rule-based logic. For instance, an exemplary rule might specify: “If a user enters instruction X, then affect change Y to engine resource 112 of process 106, and affect change Z to procedure 120 of process 108.” Such rules can be stored in the couplings database 244, and this information may effectively reflect empirical knowledge garnished from the business processes (106, 108, . . . 110) over time (e.g., in response to observed causal relationships between changes made within a business 102 and their respective effects). Effectively, then, this coupling database 244 constitutes the “control coupling” between the digital cockpit 104 and the business processes (106, 108, . . . 110) which it controls in a manner analogous to the control coupling between a control module of a physical system and the subsystems which it controls. In other implementations, still more complex strategies can be used to provide control of the business 102, such as artificial intelligence systems (e.g., expert systems) for translating a cockpit user 138's commands to the instructions appropriate to affect such instructions.

The cockpit user 138 can receive information provided by the cockpit control module 132 using different devices or different media. FIG. 2 shows the use of computer workstations 246 and 248 for presenting cockpit information to cockpit users 138 and 250, respectively. However, the cockpit control module 132 can be 26, configured to provide cockpit information to users using laptop computing devices, personal digital assistant (PDA) devices, cellular telephones, printed media, or other technique or device for information dissemination (none of which are shown in FIG. 2).

The exemplary workstation 246 includes conventional computer hardware, including a processor 252, RAM 254, ROM 256, a communication interface 258 for interacting with a remote entity (such as network 216), storage 260 (e.g., an optical and/or hard disc), and an input/output interface 262 for interacting with various input devices and output devices. These components are coupled together using bus 264. An exemplary output device includes the cockpit interface 134. The cockpit interface 134 can present an interactive display 266, which permits the cockpit user 138 to control various aspects of the information presented on the cockpit interface 134. Cockpit interface 134 can also present a static display 268, which does not permit the cockpit user 138 to control the information presented on the cockpit interface 134. The application logic for implementing the interactive display 266 and the static display 268 can be provided in the memory storage of the workstation 246 (e.g., the RAM 254, ROM 256, or storage 260, etc.), or can be provided by a computing resource coupled to the workstation 246 via the network 216, such as display presentation logic 236 provided in the cockpit control module 132.

Finally, an input device 270 permits the cockpit user 138 to interact with the workstation 246 based on information displayed on the cockpit interface 134. The input device 270 can include a keyboard, a mouse device, a joy stick, a data glove input mechanism, throttle input mechanism, track ball input mechanism, a voice recognition input mechanism, a graphical touch-screen display field, various kinds of biometric input devices, various kinds of biofeedback input devices, etc., or any combination of these devices.

FIG. 3 provides an exemplary cockpit interface 134 for one business environment. The interface can include a collection of windows (or more generally, display fields) for presenting information regarding the past, present, and future course of the business 102, as well as other information. For example, windows 302 and 304 present information regarding the current business climate (i.e., environment) in which the business 102 operates. That is, for instance, window 302 presents industry information associated with the particular type of business 102 in which the digital cockpit 104 is deployed, and window 304 presents information regarding economic indicators pertinent to the business 102. Of course, this small sampling of information is merely illustrative; a great variety of additional information can be presented regarding the business environment in which the business 102 operates.

Window 306 provides information regarding the past course (i.e., history) of the business 102, as well as its present state. Window 308 provides information regarding both the past, current, and projected future condition of the business 102. The cockpit control module 132 can generate the information shown in window 308 using one or more models 136. Although not shown, the cockpit control module 132 can also calculate and present information regarding the level of confidence associated with the business predictions shown in window 308. Additional information regarding the presentation of confidence information is presented in section E of this disclosure. Again, the predictive information shown in windows 306 and 308 is strictly illustrative; a great variety of additional presentation formats can be provided depending on the business environment in which the business 102 operates and the design preferences of the cockpit designer. Additional presentation strategies include displays having confidence bands, n-dimensional graphs, and so on.

The cockpit interface 134 can also present interactive information, as shown in window 310. This window 310 includes an exemplary multi-dimensional response surface 312. Although response surface 312 has three dimensions, response surfaces having more than three dimensions can be presented. The response surface 312 can present information regarding the projected future course of business 102, where the z-axis of the response surface 312 represents different slices of time. The window 310 can further include a display control interface 314 which allows the cockpit user 138 to control the presentation of information presented in the window 310. For instance, in one implementation, the display control interface 314 can include an orientation arrow that allows the cockpit user 138 to select a particular part of the displayed response surface 312, or which allows the cockpit user 138 to select a particular vantage point from which to view the response surface 312. Again, additional details regarding this aspect of the cockpit interface 134 are discussed in Section E of this disclosure

The cockpit interface 134 further includes another window 316 that provides various control mechanisms. Such control mechanisms can include a collection of graphical input knobs or dials 318, a collection of graphical input slider bars 320, a collection of graphical input toggle switches 322, as well as various other graphical input devices 324 (such as data entry boxes, radio buttons, etc.). These graphical input mechanisms (318, 320, 322, 324) are implemented, for example, as touch sensitive fields in the cockpit interface 134. Alternatively, these input mechanisms (318, 320, 322, 324) can be controlled via other input devices, or can be replaced by other input devices. Exemplary alternative input devices were identified above in the context of the discussion of input device(s) 270 of FIG. 2. The window 316 can also provide an interface to other computing functionality provided by the business; for instance, the digital cockpit 104 can also receive input data from a “meta-model” used to govern a more comprehensive aspect of the business.

In one use, the input mechanisms (318, 320, 322, 324) provided in the window 320 can be used to input various what-if assumptions. The entry of this information prompts the digital cockpit 104 to generate scenario forecasts based on the input what-if assumptions. More specifically, the cockpit interface 134 can present output results using the two-dimensional presentation shown in window 308, the three-dimensional presentation shown in window 310, an n-dimensional presentation (not shown), or some other format (such as bar chart format, spread sheet format, etc.).

In another use, the input mechanisms (318, 320, 322, 324) provided in window 316 can be used to enter do-what commands. As described above, the do-what commands can reflect decisions made by the cockpit user 138 based on his or her business judgment, that, in turn, can reflect the cockpit user's business experience. Alternatively, the do-what commands may be based on insight gained by running one or more what-if scenarios. As will be described, the cockpit user 138 can manually initiate these what-if scenarios or can rely, in whole or in part, on automated algorithms provided by the digital cockpit 104 to sequence through a number of what-if scenarios using an optimization strategy. As explained above, the digital cockpit 104 propagates instructions based on the do-what commands to different target processes (106, 108, . . . 110) in the business 102 to affect specified changes in the business 102.

Generally speaking, the response surface 312 (or other type of presentation provided by the cockpit interface 134) can provide a dynamically changing presentation in response to various events fed into the digital cockpit 104. For instance, the response surface 312 can be computed using a model 136 that generates output results based, in part, on data collected from the processes (106, 108, . . . 110) and stored in the data warehouses 208. As such, changes in the processes (106, 108, . . . 110) will prompt real time or near real time corresponding changes in the response surface 312. Further, the cockpit user 138 can dynamically make changes to what-if assumptions via the input mechanisms (318, 320, 322, 324) of the control panel 316. These changes can induce corresponding lockstep dynamic changes in the response surface 312.

By way of summary, the cockpit interface 134 provides a “window” into the operation of the business 102, and also provides an integrated command and control center for making changes to the business 102. The cockpit interface 134 also allows the cockpit user 138 to conveniently switch between different modes of operation. For instance, the cockpit interface 134 allows the user to conveniently switch between a what-if mode of analysis (in which the cockpit user 138 investigates the projected probabilistic outcomes of different case scenarios) and a do-what mode of command (in which the cockpit user 138 enters various commands for propagation throughout the business 102). While the cockpit interface 134 shown in FIG. 3 contains all of the above-identified windows (302, 304, 306, 308, 310, 316) on a single display presentation, it is possible to devote separate display presentations for one or more of these windows, etc.

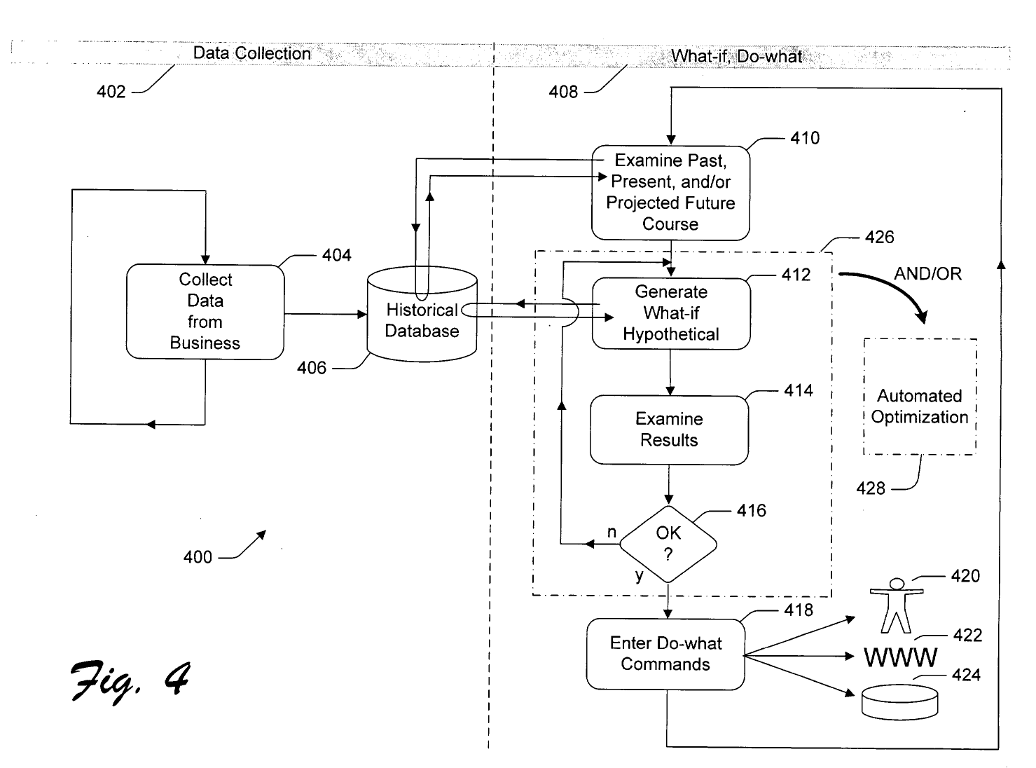

FIG. 4 presents a general exemplary method 400 that describes how the digital cockpit 104 can be used. In a data collection portion 402 of the method 400, step 404 entails collecting data from the processes (106, 108, . . . 110) within the business 102. Step 404 can be performed at prescribed intervals (such as every minute, every hour, every day, every week, etc.), or can be performed in response to the occurrence of predetermined events within the business 102. For instance, step 404 can be performed when it is determined that the amount of information generated by the business processes (106, 108, . . . 110) exceeds a predetermined threshold, and hence needs to be processed. In any event, the business processes (106, 108, . . . 110) forward information collected in step 404 to the historical database 406. The historical database 406 can represent the data warehouse 208 shown in FIG. 2, or some other storage device. The digital cockpit 104 receives such information from the historical database 406 and generates one or more fields of information described in connection with FIG. 1. Such information can include: “what was” information, providing a summary of what has happened in the business 102 in a defined prior time interval; “what-is” information, providing a summary of the current state of the business 102; and “what-may” information, providing forecasts on a projected course that the business 102 may take in the future.

In a what-if/do-what portion 408 of the method 400, in step 410, a cockpit user 138 examines the output fields of information presented on the cockpit interface 134 (which may include the above-described what-has, what-is, and what-may fields of information). The looping path between step 410 and the historical database 406 generally indicates that step 410 utilizes the information stored in the historical database 406.

Presume that, based on the information presented in step 410, the cockpit user 138 decides that the business 102 is currently headed in a direction that is not aligned with a desired goal. For instance, the cockpit user 138 can use the what-may field 144 of cockpit interface 134 to conclude that the forecasted course of the business 102 will not satisfy a stated goal. To remedy this problem, in step 412, the cockpit user 138 can enter various what-if hypothetical cases into the digital cockpit 104. These what-if cases specify a specific set of conditions that could prevail within the business 102, but do not necessarily match current conditions within the business 102. This prompts the digital cockpit 104 to calculate what may happen if the stated what-if hypothetical input case assumptions are realized. Again, the looping path between step 412 and the historical database 406 generally indicates that step 412 utilizes the information stored in the historical database 406. In step 414, the cockpit user 138 examines the results of the what-if predictions. In step 416, the cockpit user 138 determines whether the what-if predictions properly set the business 102 on a desired path toward a desired target. If not, the cockpit user 138 can repeat steps 412 and 414 for as many times as necessary, successively entering another what-if input case assumption, and examining the output result based on this input case assumption.

Assuming that the cockpit user 138 eventually settles on a particular what-if case scenario, in step 418, the cockpit user 138 can change the business processes (106, 108, . . . 110) to carry out the simulated what-if scenario. The cockpit user 138 can perform this task by entering do-what commands into the do-what field 148 of the cockpit interface 134. This causes the digital cockpit 104 to propagate appropriate instructions to targeted resources used in the business 102. For instance, command path 420 sends instructions to personnel used in the business 102. These instructions can command the personnel to increase the number of workers assigned to a task, decrease the number of workers assigned to a task, change the nature of the task, change the amount of time spent in performing the task, change the routing that defines the “input” fed to the task, or other specified change. Command path 422 sends instructions to various destinations over a network, such as the Internet (WWW), a LAN network, etc. Such destinations may include a supply chain entity, a financial institution (e.g., a bank), an intra-company subsystem, etc. Command path 424 sends instructions to engines (112, 118, 124) used in the processes (106, 108, . . . 110) of the business 102. These instructions can command the engines (112, 118, 124) to change its operating parameters, change its input data, change its operating strategy, as well as other changes.

In summary, the method shown in FIG. 4 allows a cockpit user 138 to first simulate or “try out” different what-if scenarios in the virtual business setting of the cockpit interface 134. The cockpit user 138 can then assess the appropriateness of the what-if cases in advance of actually implementing these changes in the business 102. The generation of what-if cases helps reduce inefficiencies in the governance of the business 102, as poor solutions can be identified in the virtual realm before they are put into place and affect the business processes (106, 108, . . . 110).

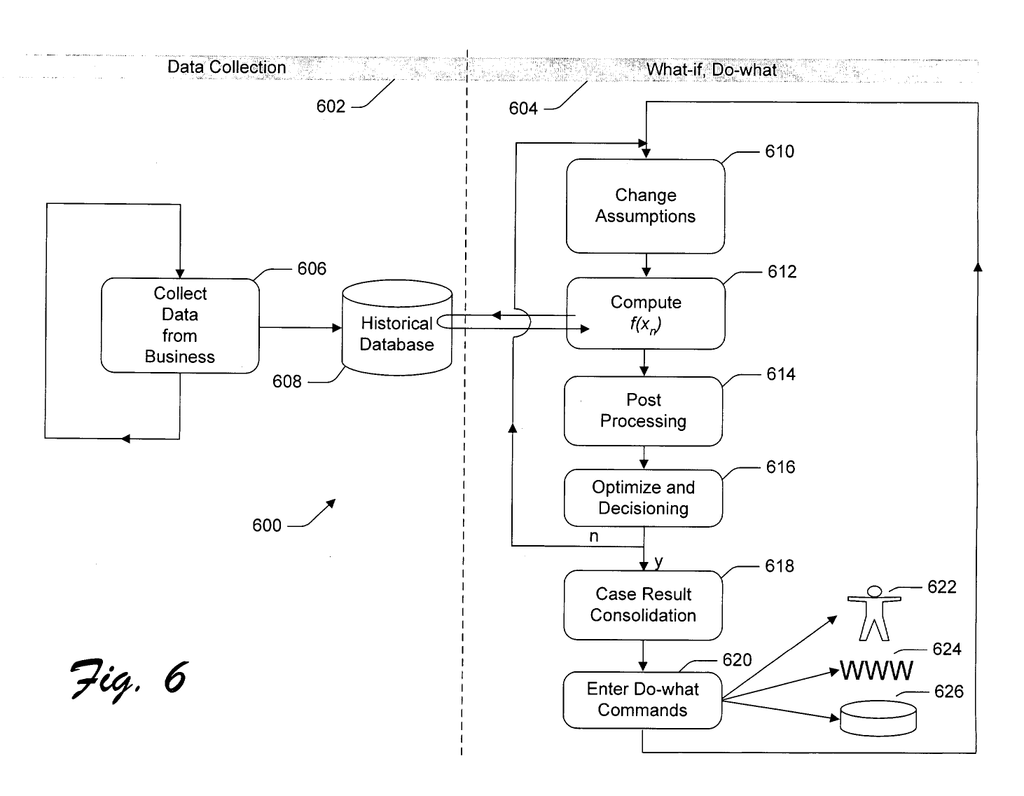

Steps 412, 414 and 416 collectively represent a manual routine 426 used to explore a collection of what-if case scenarios. In another implementation, the manual routine 426 can be supplemented or replaced with an automated optimization routine 428. As will be described more fully in connection with FIG. 6 below, the automated optimization routine 428 can automatically sequence through a number of case assumptions and then select one or more case assumptions that best accomplish a predefined objective (such as maximizing profitability, minimizing risk, etc.). The cockpit user 138 can use the recommendation generated by the automated optimization routine 428 to select an appropriate do-what command. Alternatively, the digital cockpit 104 can automatically execute an automatically selected do-what command without involvement of the cockpit user 138.

In one implementation, the automated optimization routine 428 can be manually initiated by the cockpit user 138, for example, by entering various commands into the cockpit interface 134. In another implementation, the automated optimization routine 428 can be automatically triggered in response to predefined events. For instance, the automated optimization routine 428 can be automatically triggered if various events occur within the business 102, as reflected by collected data stored in the data warehouses 208 (such as the event of the collected data exceeding or falling below a predefined threshold). Alternatively, the analysis shown in FIG. 4 can be performed at periodic scheduled times in automated fashion.

In any event, the output results generated via the process 400 shown in FIG. 4 can be archived, e.g., within the database 234 of FIG. 2. Archiving the generated output results allows these results to be retrieved if these output results are needed again at a later point in time, without incurring the delay that would be required to recalculate the output results. Additional details regarding the archiving of output results is presented in Section D of this disclosure.

To summarize the discussion of FIGS. 1-4, three analogies can be made between an airplane cockpit (or other kind of vehicle cockpit) and a business digital cockpit 104 to clarify the functionality of the digital cockpit 104. First, an airplane can be regarded as an overall engineered system including a collection of subsystems. These subsystems may have known transfer functions and control couplings that determine their respective behavior. This engineered system enables the flight of the airplane in a desired manner under the control of a pilot or autopilot. In a similar fashion, a business 102 can also be viewed as an engineered system comprising multiple processes and associated systems (e.g., 106, 108, 110). Like an airplane, the business digital cockpit 104 also includes a steering control module 152 that allows the cockpit user 138 or “auto-pilot” (representative of the automated optimization routine 428) to make various changes to the processes (106, 108, . . . 110) to allow the business 102 to carry out a mission in the face of various circumstances (with the benefit of information in past, present, and future time domains).

Second, an airplane cockpit has various gauges and displays for providing substantial quantities of past and current information pertaining to the airplane's flight, as well as to the status of subsystems used by the airplane. The effective navigation of the airplane demands that the airplane cockpit presents this information in a timely, intuitive, and accessible form, such that it can be acted upon by the pilot or autopilot in the operation of the airplane. In a similar fashion, the digital cockpit 104 of a business 102 also can present summary information to assist the user in assessing the past and present state of the business 102, including its various “engineering” processes (106, 108, . . . 110).

Third, an airplane cockpit also has various forward-looking mechanisms for determining the likely future course of the airplane, and for detecting potential hazards in the path of the airplane. For instance, the engineering constraints of an actual airplane prevent it from reacting to a hazard if given insufficient time. As such, the airplane may include forward-looking radar to look over the horizon to see what lies ahead so as to provide sufficient time to react. In the same way, a business 102 may also have natural constraints that limit its ability to react instantly to assessed hazards or changing market conditions. Accordingly, the digital cockpit 104 of a business 102 also can present various business predictions to assist the user in assessing the probable future course of the business 102. This look-ahead capability can constitute various forecasts and what-if analyses.

Additional details regarding the what-functionality, do-what functionality, pre-calculation of model output results, and visualization of model uncertainty are presented in the sections which follow.

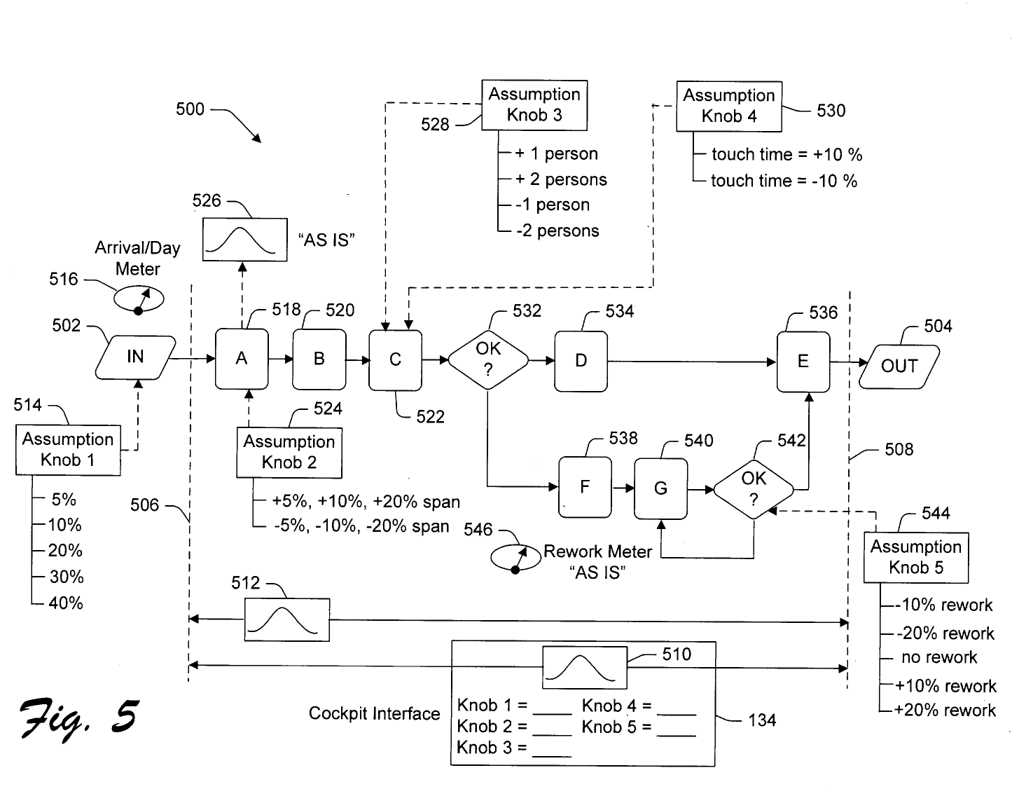

B. What-if Functionality (with Reference to FIGS. 5 and 6)

Returning briefly to FIG. 3, as explained, the digital cockpit interface 134 includes a window 316 that provides a collection of graphical input devices (318, 320, 322, 324). In one application, these graphical input devices (318, 320, 322, 324) are used to define input case assumptions that govern the generation of a what-if (i.e., hypothetical) scenario. For instance, assume that the success of a business 102 can be represented by a dependent output variable Y, such as revenue, sales volume, etc. Further assume that the dependent Y variable is a function of a set of independent X variables, e.g., Y=f(X₁, X₂, X₃, . . . Xₙ), where “f” refers to a function for mapping the independent variables (X₁, X₂, X₃, . . . Xₙ) into the dependent variable Y. An X variable is said to be “actionable” when it corresponds to an aspect of the business 102 that the business 102 can deliberately manipulate. For instance, presume that the output Y variable is a function, in part, of the size of the business's 102 sales force. A business 102 can control the size of the workforce by hiring additional staff, transferring existing staff to other divisions, laying off staff, etc. Hence, the size of the workforce represents an actionable X variable. In the context of FIG. 3, the graphical input devices (318, 320, 322, 324) can be associated with such actionable X variables. In another implementation, at least one of the graphical input devices (318, 320, 322, 324) can be associated with an X variable that is not actionable.

To simulate a what-if scenario, the cockpit user 138 adjusts the input devices (318, 320, 322, 324) to select a particular permutation of actionable X variables. The digital cockpit 104 responds by simulating how the business 102 would react to this combination of input actionable X variables as if these actionable X variables were actually implemented within the business 102. The digital cockpit's 104 predictions can be presented in the window 310, which displays an n-dimensional response surface 312 that maps the output result Y variable as a function of other variables, such as time, and/or possibly one of the actionable X variables.

In one implementation, the digital cockpit 104 is configured to allow the cockpit user 138 to select the variables that are to be assigned to the axes of the response surface 312. For instance, the cockpit user 138 can initially assign a first actionable X variable to one of the axes in response surface 322, and then later reassign that axis to another of the actionable X variables. In addition, as discussed in Section A, the digital cockpit 104 can be configured to dynamically display changes to the response surface 312 while the cockpit user 138 varies one or more input mechanisms (318, 320, 322, 324). The real-time coupling between actuations made in the control window 316 and changes presented to the response surface 312 allows the cockpit user 138 to gain a better understanding of the characteristics of the response surface 312.

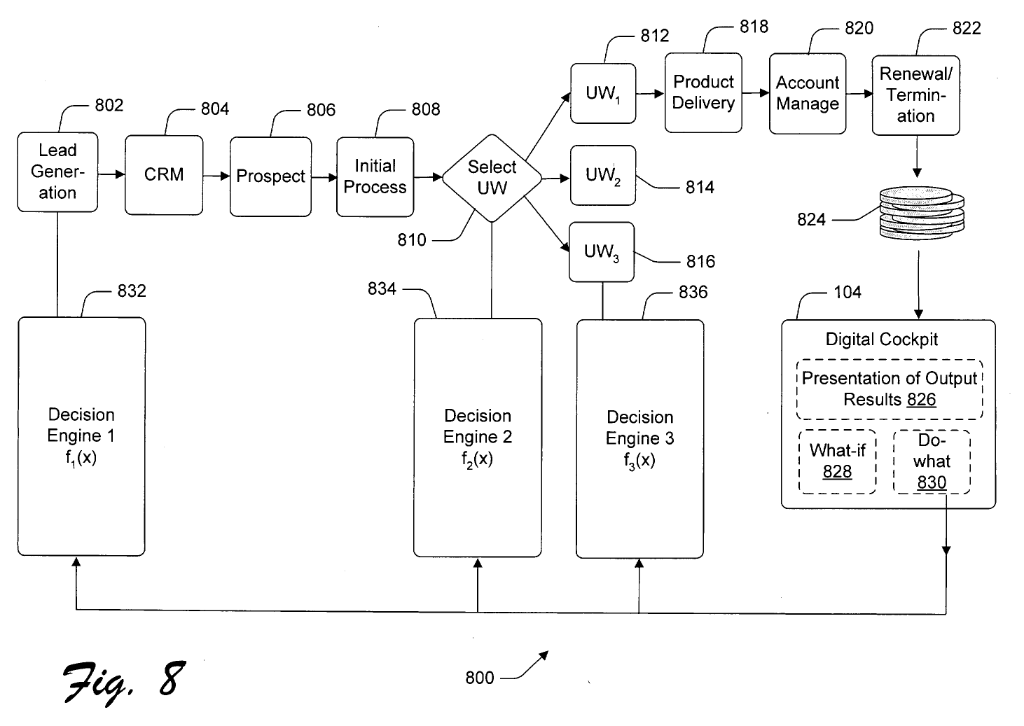

With reference now to FIGS. 5 and 6, FIG. 5 shows how the digital cockpit 104 can be used to generate what-if simulations in one exemplary business application 500. (Reference to the business as the generic business 102 shown in FIG. 1 will be omitted henceforth, so as to facilitate the discussion). FIG. 5 specifically can pertain to a process for leasing assets to customers. In this process, an input to the process represents a group of candidate customers that might wish to lease assets, and the output represents completed lease transactions for a respective subset of this group of candidate customers. This application 500 is described in more detail in FIG. 8 in the specific context of the leasing environment. However, the principles conveyed in FIG. 5 also apply to many other business environments besides the leasing environment. Therefore, to facilitate discussion, the individual process steps in FIG. 5 are illustrated and discussed as generic processing tasks, the specific nature of which is not directly of interest to the concepts being conveyed in FIG. 5. That is, FIG. 5 shows generic processing steps A, B, C, D, E, F, and G that can refer to different operations depending of the context of the business environment in which the technique is employed. Again, the application of FIG. 5 to the leasing of assets will be discussed in the context of FIG. 8.

The output variable of interest in FIG. 5 is cycle time (which is a variable that is closely related to the metric of throughput). In other words, the Y variable of interest is cycle time. Cycle time refers to a span of time between the start of the business process and the end of the business process. For instance, like a manufacturing process, many financial processes can be viewed as transforming input resources into an output “product” that adds value to the business 102. For example, in a sales context, the business transforms a collection of business leads identifying potential sources of revenue for the business into output products that represents a collection of finalized sales transactions (having valid contracts formed and finalized). The cycle time in this context refers to the amount of time it takes to transform the “starting material” to the final financial product. In the context of FIG. 5, input box 502 represents the input of resources into the process 500, and output box 504 represents the generation of the final financial product. A span between vertical lines 506 and 508 represents the amount of time it takes to transform the input resources to the final financial product.

The role of the digital cockpit 104 in the process 500 of FIG. 5 is represented by cockpit interface 134, which appears at the bottom of the figure. As shown there, in this business environment, the cockpit interface 134 includes an exemplary five input “knobs.” The use of five knobs is merely illustrative. In other implementations, other kinds of input mechanisms can be used besides knobs. Further, in other implementations, different numbers of input mechanisms can be used besides the exemplary five input mechanisms shown in FIG. 5. Each of these knobs is associated with a different actionable X variable that affects the output Y variable, which, in this case, is cycle time. Thus, in a what-if simulation mode, the cockpit user 138 can experiment with different permutations of these actionable X variables by independently adjusting the settings on these five input knobs. Different permutations of knob settings define an “input case assumption.” In another implementation, an input case assumption can also include one or more assumptions that are derived from selections made using the knob settings (or made using other input mechanisms). In response, the digital cockpit 104 simulates the effect that this input case assumption will have on the business process 500 by generating a what-if output result using one or more models 136. The output result can be presented as a graphical display that shows a predicted response surface, e.g., as in the case of response surface 312 of window 310 (in FIG. 3). The cockpit user 114 can examine the predicted output result and decide whether the results are satisfactory. That is, the output results simulate how the business will perform if the what-if case assumptions were actually implemented in the business. If the results are not satisfactory (e.g., because the results do not achieve a desired objective of the business), the user can adjust the knobs again to provide a different case assumption, and then again examine the what-if output results generated by this new input case assumption. As discussed, this process can be repeated until the cockpit user 138 is satisfied with the output results. At this juncture, the cockpit user 138 then uses the do-what functionality to actually implement the desired input case assumption represented by the final setting of what-if assumption knobs.

In the specific context of FIG. 5, the digital cockpit 104 provides a prediction of the cycle time of the process in response to the settings of the input knobs, as well as a level of confidence associated with this prediction. For instance, the digital cockpit 104 can generate a forecast that a particular input case assumption will result in a cycle time that consists of a certain amount of hours coupled with an indication of the statistical confidence associated with this prediction. That is, for example, the digital cockpit 104 can generate an output that informs the cockpit user 138 that a particular knob setting will result in a cycle time of 40 hours, and that there is a 70% confidence level associated with this prediction (that is, there is a 70% probability that the actual measured cycle time will be 40 hours). A cockpit user 138 may be dissatisfied with this predicted result for one of two reasons (or both reasons). First, the cockpit user 138 may find that the predicted cycle time is too long. For instance, the cockpit user 138 may determine that a cycle time of 30 hours or less is required to maintain competitiveness in a particular business environment. Second, the cockpit user 138 may feel that the level of confidence associated with the predicted result is too low. For a particular business environment, the cockpit user 138 may want to be assured that a final product can be delivered with a greater degree of confidence. This can vary from business application to business application. For instance, the customers in one financial business environment might be highly intolerant to fluctuations in cycle time, e.g., because the competition is heavy, and thus a business with unsteady workflow habits will soon be replaced by more stable competitors. In other business environments, an untimely output product may subject the customer to significant negative consequences (such as by holding up interrelated business operations), and thus it is necessary to predict the cycle time with a relatively high degree of confidence.

FIG. 5 represents the confidence associated with the predicted cycle time by a series of probability distribution graphs. For instance, the digital cockpit interface 134 presents a probability distributions graph 510 to convey the confidence associated with a predicted output. More specifically, a typical probability distribution graph represents a calculated output variable on the horizontal axis, and probability level on the vertical axis. For instance, if several iterations of a calculation are run, the vertical axis can represent the prevalence at which different predicted output values are encountered (such as by providing count or frequency information that identifies the prevalence at which different predicted output values are encountered). A point along the probability distribution curve thus represents the probability that a value along the horizontal axis will be realized if the case assumption is implemented in the business. Probability distribution graphs typically assume the shape of a symmetrical peak, such as a normal distribution, triangular distribution, or other kind of distribution. The peak identifies the calculated result having the highest probability of being realized. The total area under the probability distribution curve is 1, meaning that that there is a 100% probability that the calculated result will fall somewhere in the range of calculated values spanned by the probability distribution. In another implementation, the digital cockpit 104 can represent the information presented in the probability distribution curve using other display formats, as will be described in greater detail in Section E of this disclosure. By way of clarification, the term “probability distribution” is used broadly in this disclosure. This term describes graphs that present mathematically calculated probability distributions, as well as graphs that present frequency count information associated with actual sampled data (where the frequency count information can often approximate a mathematically calculated probability distribution).

More specifically, the probability distribution curve 510 represents the simulated cycle time generated by the models 136 provided by the digital cockpit 104. Generally, different factors can contribute to uncertainty in the predicted output result. For instance, the input information and assumptions fed to the models 136 may have uncertainty associated therewith. For instance, such uncertainty may reflect variations in transport times associated with different tasks within the process 500, variations in different constraints that affect the process 500, as well as variations associated with other aspects of the process 500. This uncertainty propagates through the models 136, and results in uncertainty in the predicted output result.

More specifically, in one implementation, the process 500 collects information regarding its operation and stores this information in the data warehouse 208 described in FIG. 2. A selected subset of this information (e.g., comprising data from the last six months) can be fed into the process 500 shown in FIG. 5 for the purpose of performing “what-if” analyses. The probabilistic distribution in the output of the process 500 can represent the actual variance in the collection of information fed into the process 500. In another implementation, uncertainty in the input fed to the models 136 can be simulated (rather than reflecting variance in actual sampled business data). In addition to the above-noted sources uncertainty, the prediction strategy used by a model 136 may also have inherent uncertainty associated therewith. Known modeling techniques can be used to assess the uncertainty in an output result based on the above-identified factors.

Another probability distribution curve 512 is shown that also bridges lines 506 and 508 (demarcating, respectively, the start and finish of the process 500). This probability distribution curve 512 can represent the actual uncertainty in the cycle time within process 500. That is, products (or other sampled entities) that have been processed by the process 500 (e.g., in the normal course of business) receive initial time stamps upon entering the process 500 (at point 506) and receive final time stamps upon exiting the process 500 (at point 508). The differences between the initial and final time stamps reflect respective different cycle times. The probability distribution curve 512 shows the prevalence at which different cycle times are encountered in the manner described above.

A comparison of probability distribution curve 512 and probability distribution curve 510 allows a cockpit user 138 to assess the accuracy of the digital cockpit's 104 predictions and take appropriate corrective measures in response thereto. In one case, the cockpit user 138 can rely on his or her business judgment in comparing distribution curves 510 and 512. In another case, the digital cockpit 104 can provide an automated mechanism for comparing salient features of distribution curves 5 10 and 512. For instance, this automated mechanism can determine the variation between the mean values of distributions curves 510 and 512, the variation between the shapes of distributions 510 and 512, and so on.

With the above introduction, it is now possible to describe the flow of operations in FIG. 5, and the role of the assumption knobs within that flow. The process begins in step 502, which represents the input of a collection of resources. Assumption knob 1 (514) governs the flow of resources in the process. This assumption knob (514) can be increased to increase the flow of resources into the process by a predetermined percentage (from a baseline flow). A meter 516 denotes the amount of resources being fed into the process 500. As mentioned, the input of resources into the process 500 marks the commencement of the cycle time interval (denoted by vertical line 506). As will be described in a later portion of this disclosure, in one implementation, the resources (or other entities) fed to the process 500 have descriptive attributes that allow the resources to be processed using conditional decisioning mechanisms.

The actual operations performed in boxes A, B, and C (518, 520, and 522, respectively) are not of interest to the principles being conveyed by FIG. 5. These operations will vary for different business applications. But, in any case, assumption knob 2 (524) controls the span time associated with an operation A (518). That is, this assumption knob 2 (524) controls the amount of time that it takes to perform whatever tasks are associated with operation A (518). For example, if the business represents a manufacturing plant, assumption knob 2 (524) could represent the time required to process a product using a particular machines or machines (that is, by transforming the product from an input state to an output state using the machine or machines). The assumption knob 2 (524) can specifically be used to increase a prevailing span type by a specified percentage, or decrease a prevailing span time by a specified percentage. “As is” probability distribution 526 represents the actual probability distribution of cycle time through operation A (518). Again, the functions performed by operation B (520) are not of relevance to the context of the present discussion.

Assumption knob 3 (528) adjusts the workforce associated with whatever tasks are performed in operation C (522). More specifically, this assumption knob 3 (528) can be used to incrementally increase the number of staff from a current level, or incrementally decrease the number of staff from a current staff level.

Assumption knob 4 (530) also controls operation C (522). That is, assumption knob 4 (530) determines the amount of time that workers allocate to performing their assigned tasks in operation C (522), which is referred to as “touch time.” Assumption knob 4 (530) allows a cockpit user 138 to incrementally increase or decrease the touch time by percentage levels (e.g., by +10 percent, or −10 percent, etc.).

In decision block 532, the process 500 determines whether the output of operation C (522) is satisfactory by comparing the output of operation C (522) with some predetermined criterion (or criteria). If the process 500 determines that the results are satisfactory, then the flow proceeds to operation D (534) and operation E (536). Thereafter, the final product is output in operation 504. If the process 500 determines that the results are not satisfactory, then the flow proceeds to operation F (538) and operation G (540). Again, the nature of the tasks performed in each of these operations not germane to the present discussion, and can vary depending on the business application. In decision box 542, the process 500 determines whether the rework performed in operation F (538) and operation G (step 540) has provided a desired outcome. If so, the process advances to operation E (536), and then to output operation (504). If not, then the process 500 will repeat operation G (540) for as many times as necessary to secure a desirable outcome. Assumption knob 5 (544) allows the cockpit user 138 to define the amount of rework that should be performed to provide a satisfactory result. The assumption knob 5 (544) specifically allows the cockpit user 138 to specify the incremental percentage of rework to be performed. A rework meter 546 measures, in the context of the actual performance of the business flow, the amount of rework that is being performed.

By successively varying the collection of input knobs in the cockpit interface 134, the cockpit user 138 can identify particularly desirable portions of the predictive model's 136 response surface in which to operate the business process 500. One aspect of “desirability” pertains to the generation of desired target results. For instance, as discussed above, the cockpit user 138 may want to find that portion of the response surface that provides a desired cycle time (e.g., 40 hours, 30 hours, etc.). Another aspect of desirability pertains to the probability associated with the output results. The cockpit user 138 may want to find that portion of the response surface that provides adequate assurance that the process 500 can realize the desired target results (e.g., 70% confidence 80% confidence, etc.). Another aspect of desirability pertains to the generation of output results that are sufficiently resilient to variation. This will assure the cockpit user 138 that the output results will not dramatically change when only a small change in the case assumptions and/or “real world” conditions occurs. Taken all together, it is desirable to find the parts of the response surface that provide an output result that is on-target as well as robust (e.g., having suitable confidence and stability levels associated therewith). The cockpit user 138 can also use the above-defined what-if analysis to identify those parts of the response surface that the business distinctly does not want to operate within. The knowledge gleaned through this kind of use of the digital cockpit 104 serves a proactive role in steering the business away from a hazard. This aspect of the digital cockpit 104 is also valuable in steering the business out of a problematic business environment that it has ventured into due to unforeseen circumstances.

An assumption was made in the above discussion that the cockpit user 138 manually changes the assumption knobs in the cockpit interface 134 primarily based on his or her business judgment. That is, the cockpit user 138 manually selects a desired permutation of input knob settings, observes the result on the cockpit interface 134, and then selects another permutation of knob settings, and so on. However, in another implementation, the digital cockpit 104 can automate this trial and error approach by automatically sequencing through a series of input assumption settings. Such automation was introduced in the context of step 428 of FIG. 4.

FIG. 6 illustrates a process 600 that implements an automated process for input assumption testing. FIG. 6 generally follows the arrangement of steps shown in FIG. 4. For instance, the process 600 includes a first series of steps 602 devoted to data collection, and another series of steps 604 devoted to performing what-if and do-what operations.

As to the data collection series of steps 602, step 606 involves collecting information from processes within a business, and then storing this information in a historical database 608, such as the data warehouse 208 described in the context of FIG. 2.

As to the what-if/do-what series of steps 604, step 610 involves selecting a set of input assumptions, such as a particular combination of actionable X variables associated with a set of input knobs provided on the cockpit interface 134. Step 612 involves generating a prediction based on the input assumptions using a model 136 (e.g., a model which provides an output variable, Y, based on a function, f(X)). In one implementation, step 612 can use multiple different techniques to generate the output variable Y, such as Monte Carlo simulation techniques, discrete event simulation techniques, continuous simulation techniques, and other kinds of techniques. Step 614 involves performing various post-processing tasks on the output of the model 136. The post-processing operations can vary depending on the nature of a particular business application. In one case, step 614 entails consolidating multiple scenario results from different analytical techniques used in step 612. For example, step 612 may have involved using a transfer function to run 500 different case computations. These computations may have involved sampling probabilistic input assumptions in order to provide probabilistic output results. In this context, the post-processing step 614 entails combining and organizing the output results associated with different cases and making the collated output probability distribution available for downstream optimization and decisioning operations.

Step 616 entails analyzing the output of the post-processing step 614 to determine whether the output result satisfies various criteria. For instance, step 616 can entail comparing the output result with predetermined threshold values, or comparing a current output result with a previous output result provided in a previous iteration of the loop shown in the what-if/do-what series of steps 604. Based on the determination made in step 616, the process 600 may decide that a satisfactory result has not been achieved by the digital cockpit 104. In this case, the process 600 returns to step 610, where a different permutation of input assumptions is selected, followed by a repetition of steps 612, 614, and 616. This thus-defined loop is repeated until step 616 determines that one or more satisfactory results have been generated by the process 600 (e.g., as reflected by the result satisfying various predetermined criteria). Described in more general terms, the loop defined by steps 610, 612, 614, and 616 seeks to determine the “best” permutation of input knob settings, where “best” is determined by a predetermined criterion (or criteria).

Different considerations can be used in sequencing through input considerations in step 610. Assume, for example, that a particular model 136 maps a predetermined number of actionable X variables into one or more Y variables. In this case, the process 600 can parametrically vary each one of these X variables while, in turn, keeping the others constant, and then examining the output result for each permutation. In another example, the digital cockpit 104 can provide more complex procedures for changing the groups of actionable X variables at the same time. Further, the digital cockpit 104 can employ a variety of automated tools for implementing the operations performed in step 610. In one implementation, the digital cockpit 104 an employ various types of rule-based engine techniques, statistical analysis techniques, expert system analysis techniques, neural network techniques, gradient search techniques, etc. to help make appropriate decisions regarding an appropriate manner for changing X variables (separately or at the same time). For instance, there may be empirical business knowledge in a particular business sector that has a bearing on what input assumptions should be tested. This empirical knowledge can be factored into the step 610 using the above-described rule-based logic or expert systems analysis, etc.

Eventually the digital cockpit 104 will arrive at one or more input case assumptions (e.g., combinations of actionable X variables) that satisfy the stated criteria. In this case, step 618 involves consolidating the output results generated by the digital cockpit 104. Such consolidation 618 can involve organizing the output results into groups, eliminating certain solutions, etc. Step 618 may also involve codifying the output results for storage to enable the output results to be retrieved at a later point in time. More specifically, as discussed in connection with FIG. 4, in one implementation, the digital cockpit 104 can archive the output results such that these results can be recalled upon the request of the cockpit user 138 without incurring the time delay required to recalculate the output results. The digital cockpit can also store information regarding different versions of the output results, information regarding the user who created the results, as well as other accounting-type information used to manage the output results.

After consolidation, step 620 involves implementing the solutions computed by the digital cockpit 104. This can involve transmitting instructions to affect a staffing-related change (as indicated by path 622), transmitting instruction over a digital network (such as the Internet) to affect a change in one or more processes coupled to the digital network (as indicated by path 624), and/or transmitting instruction to affect a desired change in engines used in the business process (as indicated by path 626). In general, the do-what commands affect changes in “resources” used in the processes, including personnel resources, software-related resources, data-related resources, capital-related resources, equipment-related resources, and so on.

The case consolidation in step 618 and the do-what operations in step 620 can be manually performed by the cockpit user 138. That is, a cockpit user 138 can manually make changes to the business process through the cockpit interface 134 (e.g., through the control window 316 shown in FIG. 3). In another implementation, the digital cockpit 104 can automate steps 618 and 620. For instance, these steps can be automated by accessing and applying rule-based decision logic that simulates the judgment of human cockpit user 138.

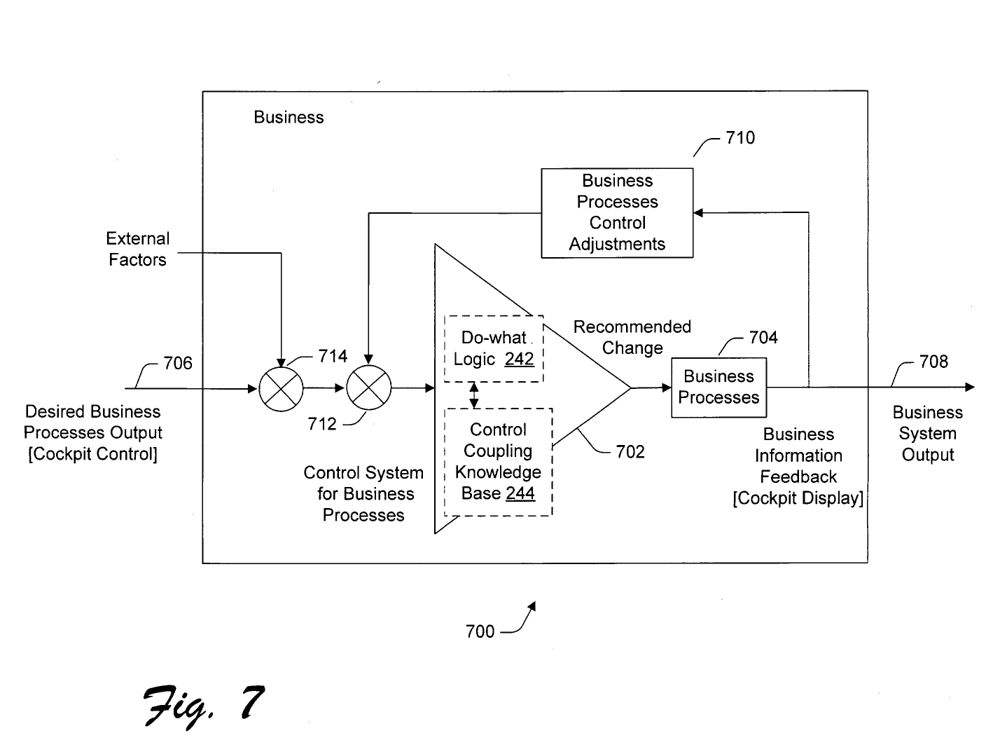

C. Do-What Functionality (with Reference to FIGS. 7 and 8)

FIGS. 7 and 8 provide additional information regarding the do-what capabilities of the digital cockpit 104. To review, the do-what functionality of the digital cockpit 104 refers to the digital cockpit's 104 ability to model the business as an engineering system of interrelated processes (each including a number of resources), to generate instructions using decisioning and control algorithms, and then to propagate instructions to the functional processes in a manner analogous to the control mechanisms provided in a physical engineering system.

The process of FIG. 7 depicts the control aspects of the digital cockpit 104 in general terms using the metaphor of an operational amplifier (op-amp) used in electronic control systems. System 700 represents the business. Control mechanism 702 represents the functionality of the digital cockpit 104 that executes control of a business process 704. An input 706 to the system 700 represent a desired outcome of the business. For instance, the cockpit user 138 can use the cockpit interface 134 to steer the business in a desired direction using the control window 316 of FIG. 3. This action causes various instructions to propagate through the business in the manner described in connection with FIGS. 1 and 2. For example, in one implementation, the control mechanism 702 includes do-what logic 242 that is used to translate the cockpit user 138's commands into a series of specific instructions that are transmitted to specific decision engines (and potentially other resources) within the business. In performing this function, the do-what logic 242 can use information stored in the control coupling database 244 (where features 242 and 244 where first introduced in FIG. 2). This information can store a collection of if-then rules that map a cockpit user's 138 control commands into specific instructions for propagation into the business. In other implementations, the digital cockpit 104 can rely on other kinds of automated engines to map the cockpit user's 138 input commands into specific instructions for propagation throughout the business, such as artificial intelligence engines, simulation engines, optimization engines, etc.

Whatever strategy is used to generate instructions, module 704 generally represents the business processes that receive and act on the transmitted instructions. In one implementation, a digital network (such as the Internet, Intranet, LAN network, etc.) can be used to transport the instructions to the targeted business processes 704. The output of the business processes 704 defines a business system output 708, which can represent a Y variable used by the business to assess the success of the business, such as financial metrics (e.g., revenue, etc.), sales volume, risk, cycle time, inventory, etc.

However, as described in preceding sections, the changes made to the business may be insufficient to steer the business in a desired direction. In other words, there may be an appreciable error between a desired outcome and the actual observed outcome produced by a change. In this event, the cockpit user 138 may determine that further corrective changes are required. More specifically, the cockpit user 138 can assess the progress of the business via the digital cockpit 104, and can take further corrective action also via the digital cockpit 104 (e.g., via the control window 316 shown in FIG. 3). Module 710 generally represents the cockpit user's 138 actions in making corrections to the course of the business via the cockpit interface 134. Further, the digital cockpit 104 can be configured to modify the cockpit user's 138 instructions prior to applying these changes to the system 700. In this case, module 710 can also represent functionality for modifying the cockpit user's 138 instructions. For instance, the digital cockpit 104 can be configured to prevent a cockpit user from making too abrupt a change to the system 700. In this event, the digital cockpit 104 can modify the cockpit user's 138 instructions to lessen the impact of these instructions on the system 700. This would have the effect of smoothing out the effect of the cockpit user's 138 instructions. In another implementation, the module 710 can control the rate of oscillations in system 700 which may be induced by the operation of the “op-amp.” Accordingly, in these cases, the module 710 can be analogized as an electrical component (e.g., resistor, capacitor, etc.) placed in the feedback loop of an actual op-amp, where this electrical component modifies the op-amp's feedback signal to achieve desired control performance.

Summation module 712 is analogous to its electrical counterpart. That is, this summation module 712 adds the system's 700 feedback from module 710 to an initial baseline and feeds this result back into the control mechanism 702. The result fed back into the control mechanism 702 also includes exogenous inputs added via summation module 714. These exogenous inputs reflect external factors which impact the business system 700. Many of these external factors cannot be directly controlled via the digital cockpit 104 (that is, these factors correspond to X variables that are not actionable). Nevertheless, these external factors affect the course of the business, and thus might be able to be compensated for using the digital cockpit 104 (e.g., by changing X variables that are actionable). The inclusion of summation module 714 in FIG. 7 generally indicates that these factors play a role in modifying the behavior of the control mechanism 702 provided by the business, and thus must be taken account of. Although not shown, additional control mechanisms can be included to pre-process the external factors before their effect is “input” into the system 700 via the summation module 714.

The output of summation module 712 is fed back into the control mechanism 702, which produces an updated system output 708. The cockpit user 138 (or an automated algorithm) then assesses the error between the system output 708 and the desired response, and then makes further corrections to the system 700 as deemed appropriate. The above-described procedure is repeated to affect control of the business in a manner analogous to a control system of a moving vehicle.

The processing depicted in FIG. 8 provides an explanation as to how the above-described general principles play out in a specific business application. More specifically, the process of FIG. 8 involves a leasing process 800. The purpose of this business process 800 is to lease assets to customers in such a manner as to generate revenue for the business, which requires an intelligent selection of “financially viable” customers (that is, customers that are good credit risks), and the efficient processing of leases for these customers. The general flow of business operations in this environment will be described first, followed by a discussion of the application of the digital cockpit 104 to this environment. In general, the operations described below can be performed manually, automatically using computerized business techniques, or using a combination of manual and automated techniques.

Beginning at the far left of FIG. 8, step 802 entails generating business leads. More specifically, the lead generation step 802 attempts to identify those customers that are likely to be interested in leasing an asset (where the term “business leads” defines candidates that might wish to lease an asset). The lead generation step 802 also attempts to determine those customers who are likely to be successfully processed by the remainder of the process 800 (e.g., defining profit-viable customers). For instance, the lead generation step 802 may identify, in advance, potential customers that share a common attribute or combination of attributes that are unlikely to “make it through” the process 800. This may be because the customers represent poor credit risks, or possess some other unfavorable characteristic relevant to a particular business sector's decision-making. Further, the culling of leads from a larger pool of candidates may reflect the business needs and goals of the leasing business, rather than simply the credit worthiness of the customers.

The lead generation step 802 feeds its recommendations into a customer relationship management (CRM) database system 804. That database system 804 serves as a central repository of customer related information for use by the sales staff in pursuing leads.

In step 806, the salespeople retrieve information from the CRM database 804 and “prospect” for leads based on this information. This can entail making telephone calls, targeted mailings, or in-person sales calls to potential customers on a list of candidates, or can entail some other marketing strategy.

In response to the sale force's prospecting activities, a subset of the candidates will typically express an interest in leasing an asset. If this is so, in step 808, appropriate individuals within the business will begin to develop deals with these candidates. This process 808 may constitute “structuring” these deals, which involves determining the basic features of the lease to be provided to the candidate in view of the candidate's characteristics (such as the customer's expectations, financial standing, etc.), as well as the objectives and constraints of the business providing the lease.

An evolving deal with a potential customer will eventually have to be underwritten. Underwriting involves assigning a risk to the lease, which generally reflects the leasing business's potential liability in forming a contractual agreement with the candidate. A customer that has a poor history of payment will prove to be a high credit risk. Further, different underwriting considerations may be appropriate for different classes of customers. For instance, the leasing business may have a lengthy history of dealing with a first class of customers, and may have had a positive experience with these customers. Alternatively, even though the leasing business does not have personal contact with a candidate, the candidate may have attributes that closely match other customers that the leasing business does have familiarity with. Accordingly, a first set of underwriting considerations may be appropriate to the above kinds of candidates. On the other hand, the leasing business may be relatively unfamiliar with another group of potential customers. Also, a new customer may pose particularly complex or novel considerations that the business may not have encountered in the past. This warrants the application of another set of underwriting considerations to this group of candidates. Alternatively, different industrial sectors may warrant the application of different underwriting considerations. Still alternatively, the amount of money potentially involved in the evolving deal may warrant the application of different underwriting considerations, and so on.

Step 810 generally represents logic that determines which type of underwriting considerations apply to a given potential customers' fact pattern. Depending on the determination in step 810, process 800 routes the evolving deal associated with a candidate to one of a group of underwriting engines. FIG. 8 shows three exemplary underwriting engines or procedures, namely, UW₁ (812), UW₂ (814), and UW₃ (816) (referred to as simply “engines” henceforth for brevity). For instance, underwriting engine UW₁ (812) can handle particularly simple underwriting jobs, which may involve only a few minutes. On the other hand, underwriting engine UW₂ (814) handles more complex underwriting tasks. No matter what path is taken, a risk level is generally assigned to the evolving deal, and the deal is priced. The process 800 can use manual and/or automatic techniques to perform pricing.

Providing that the underwriting operations are successful (that is, providing that the candidate represents a viable lessee in terms of risk and return, and providing that a satisfactory risk-adjusted price can be ascribed to the candidate), the process 800 proceeds to step 818, where the financial product (in this case, the finalized lease) is delivered to the customer. In step 820, the delivered product is added to the business's accounting system, so that it can be effectively managed. In step 822, which reflects a later point in the life cycle of the lease, the process determines whether the lease should be renewed or terminated.

The output 824 of the above-described series of lease-generating steps is a dependent Y variable that may be associated with a revenue-related metric, profitability-related metric, or other metric. This is represented in FIG. 8 by showing that a monetary asset 824 is the output by the process 800.

The digital cockpit 104 receives the dependent Y variable, for example, representative of profitability. Based on this information (as well as additional information), the cockpit user 138 determines whether the business is being “steered” in a desired direction. This can be determined by viewing an output presentation that displays the output result of various what-was, what-is, what-may, etc. analyses. The output of such analysis is generally represented in FIG. 8 as presentation field 826 of the digital cockpit 104. As has been described above, the cockpit user 138 decides whether the output results provided by the digital cockpit 104 reflects a satisfactory course of the business. If not, the cockpit user 138 can perform a collection of what-if scenarios using input field 828 of the digital cockpit 104, which helps gauge how the actual process may respond to a specific input case assumption (e.g., a case assumption involving plural actionable X variables). When the cockpit user 138 eventually arrives at a desired result (or results), the cockpit user 138 can execute a do-what command via the do-what field 830 of the digital cockpit 104, which prompts the digital cockpit 104 to propagate required instructions throughout the processes of the business. As previously described, aspects of the above-described manual process can be automated.

FIG. 8 shows, in one exemplary environment, what specific decisioning resources can be affected by the do-what commands. Namely, the process shown in FIG. 8 includes three decision engines, decision engine 1 (832), decision engine 2 (834), and decision engine 3 (836). Each of the decision engines can receive instructions generated by the do-what functionality provided by the digital cockpit 104. Three decision engines are shown in FIG. 8 as merely one illustrative example. Other implementations can include additional or fewer decision engines.

For instance, decision engine 1 (832) provides logic that assists step 802 in culling a group of leads from a larger pool of potential candidates. In general, this operation entails comparing a potential lead with one or more favorable attributes to determine whether the lead represents a viable potential customer. A number of attributes have a bearing of the desirability of the candidate as a lessee, such as whether the leasing business has had favorable dealings with the candidate in the past, whether a third party entity has attributed a favorable rating to the candidate, whether the asset to be leased can be secured, etc. Also, the candidate's market sector affiliation may represent a significant factor in deciding whether to preliminary accept the candidate for further processing in the process 800. Accordingly, the do-what instructions propagated to the decision engine 1 (832) can make adjustments to any of the parameters or rules involved in making these kinds of lead determinations. This can involve making a change to a numerical parameter or coefficient stored in a database, such as by changing the weighting associated with different scoring factors, etc. Alternatively, the changes made to decision engine 1 (832) can constitute changing the basic strategy used by the decision engine 1 (832) in processing candidates (such as by activating an appropriate section of code in the decision engine 1 (832), rather than another section of code pertaining to a different strategy). In general, the changes made to decision engine 1 (832) define its characteristics as a filter of leads. In one application, the objective is to adjust the filter such that the majority of leads that enter the process make it entirely through the process (such that the process operates like a pipe, rather than a funnel). Further, the flow of operations shown in FIG. 8 may require a significant amount of time to complete (e.g., several months, etc.). Thus, the changes provided to decision engine 1 (832) should be forward-looking, meaning that the changes made to the beginning of the process should be tailored to meet the demands that will likely prevail at the end of the process, some time later.

Decision engine 2 (834) is used in the context of step 810 for routing evolving deals to different underwriting engines or processes based on the type of considerations posed by the candidate's application for a lease (e.g., whether the candidate poses run-of-the-mill considerations, or unique considerations). Transmitting do-what instructions to this engine 2 (834) can prompt the decision engine 2 (834) to change various parameters in its database, change its decision rules, or make some other change in its resources.

Finally, decision engine 3 (836) is used to assist an underwriter in performing the underwriting tasks. This engine 3 (836) may provide different engines for dealing with different underwriting approaches (e.g., for underwriting paths UW₁, UW₂, and UW₃, respectively). Generally, software systems are known in the art for computing credit scores for a potential customer based on the characteristics associated with the customer. Such software systems may use specific mathematical equations, rule-based logic, neural network technology, artificial intelligence technology, etc., or a combination of these techniques. The do-what commands sent to engine 3 (836) can prompt similar modifications to decision engine 3 (840) as discussed above for decision engine 1 (832) and decision engine 2 (834). Namely, instructions transmitted by the digital cockpit 104 to engine 3 (836) can prompt engine 3 (836) to change stored operating parameters in its database, change its underwriting logic (by adopting one underwriting strategy rather than another), or any other modification.

The digital cockpit 104 can also control a number of other aspects of the processing shown in FIG. 8, although not specifically illustrated. For instance, the process 800 involves an intertwined series of operations, where the output of one operation feeds into another. Different workers are associated with each of these operations. Thus, if one particular employee of the process is not functioning as efficiently as possible, this employee may cause a bottleneck that negatively impacts downstream processes. The digital cockpit 104 can be used to continuously monitor the flow through the process 800, identify emerging or existing bottlenecks (or other problems in the process), and then take proactive measures to alleviate the problem. For instance, if a worker is out sick, the digital cockpit 104 can be used to detect work piling up at his or her station, and then to route such work to others that may have sufficient capacity to handle this work. Such do-what instructions may entail making changes to an automatic scheduling engine used by the process 800, or other changes to remedy the problem.

Also, instead of revenue, the digital cockpit 104 can monitor and manage cycle time associated with various tasks in the process 800. For instance, the digital cockpit 104 can be used to determine the amount of time it takes to execute the operations describes in steps 802 to 818, or some other subset of processing steps. As discussed in connection with FIG. 5, the digital cockpit 104 can use a collection of input knobs (or other input mechanisms) for exploring what-if cases associated with cycle time. The digital cockpit 104 can also present an indication of the level of confidence in its predictions, which provides the business with valuable information regarding the likelihood of the business meeting its specified goals in a timely fashion. Further, after arriving at a satisfactory simulated result, the digital cockpit 104 can allow the cockpit user 138 to manipulate the cycle time via the do-what mechanism 830.

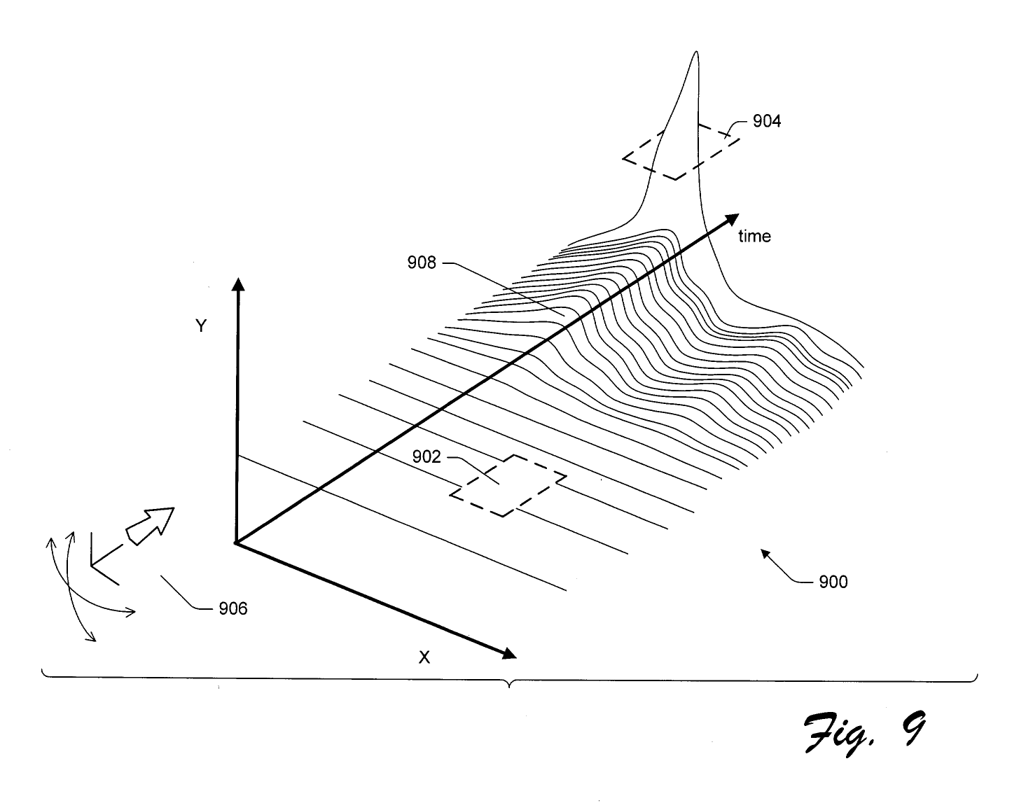

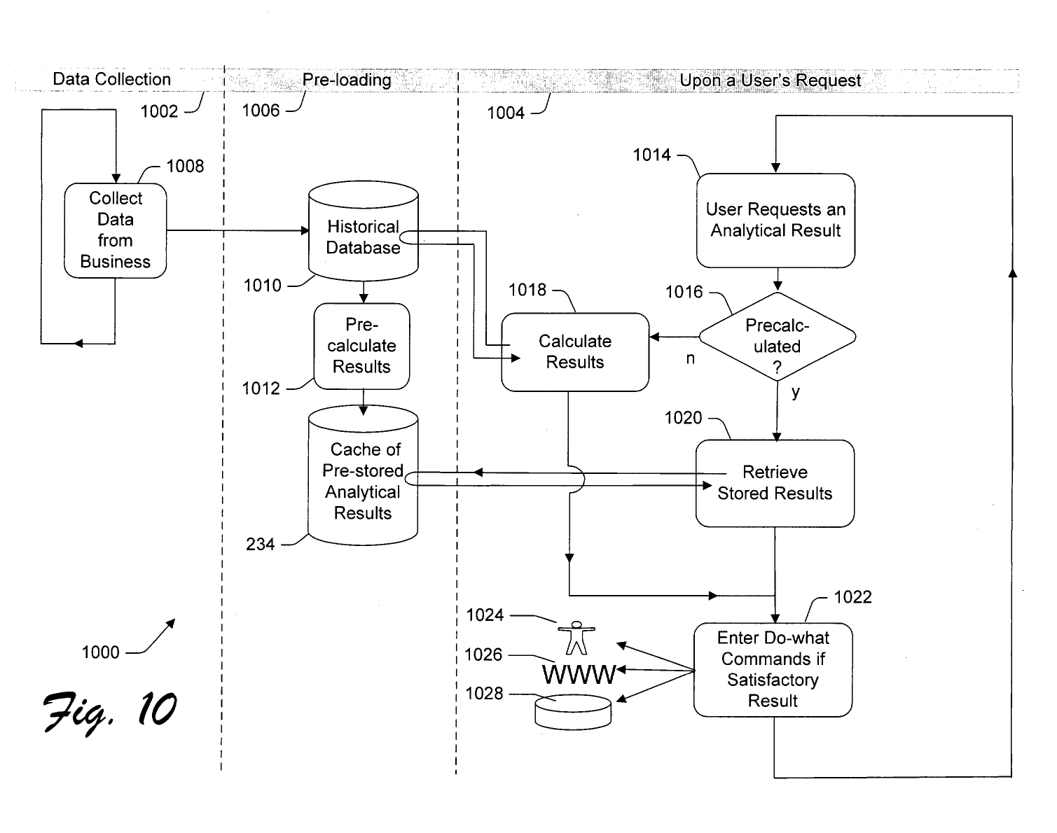

D. Pre-Loading of Results (with Reference to FIGS. 9 and 10)

As can be appreciated from the foregoing two sections, the what-if analysis may involve sequencing through a great number of permutations of actionable X variables. This may involve a great number of calculations. Further, to develop a probability distribution, the digital cockpit 104 may require much additional iteration of calculations. In some cases, this large number of calculations may require a significant amount of the time to perform, such as several minutes, or perhaps even longer. This, in turn, can impose a delay when the cockpit user 138 inputs a command to perform a what-if calculation in the course of “steering” the business. As a general intent of the digital cockpit 104 is to provide timely information in steering the business, this delay is generally undesirable, as it may introduce a time lag in the control of the business. More generally, the time lag may be simply annoying to the cockpit user 138.

This section presents a strategy for reducing the delay associated with performing multiple or complex calculations with the digital cockpit 104. By way of overview, the technique includes assessing calculations that would be beneficial to perform off-line, that is, in advance of a cockpit user 138's request for such calculations. The technique then involves storing the results. Then, when the user requests a calculation that has already been calculated, the digital cockpit 104 simply retrieves the results that have already been calculated and presents those results to the user. This provides the results to the user substantially instantaneously, as opposed to imposing a delay of minute, or hours.

Referring momentarily back to FIG. 2, the cockpit control module 132 shows how the above technique can be implemented. As indicated there, pre-loading logic 230 within analysis logic 222 determines calculations that should be performed in advance, and then proceeds to perform these calculations in an off-line manner. For instance, the pre-loading logic 230 can perform these calculations at times when the digital cockpit 104 is not otherwise busy with its day-to-day predictive tasks. For instance, these pre-calculations can be performed off-hours, e.g., at night or on the weekends, etc. Once results are computed, the pre-loading logic 230 stores the results in the pre-loaded results database 234. When the results are later needed, the pre-loading logic 230 determines that the results have already been performed, and then retrieves the results from the pre-loaded database 234. For instance, pre-calculation can be performed for specified permutations of input assumptions (e.g., specific combinations of input X variables). Thus, the results can be stored in the pre-loaded results database 234 along with an indication of the actionable X variables that correspond to the results. If the cockpit user 138 later requests an analysis that involves the same combination actionable X variables, then the digital cockpit 104 retrieves the corresponding results stored in the pre-load results database 234.

Advancing now to FIG. 9, the first stage in the above-described processing involves assessing calculations that would be beneficial to perform in advance. This determination can involve a consideration of plural criteria. That is, more than one factor may play a role in deciding what analyses to perform in advance of the cockpit user's 138 specific requests. Exemplary factors are discussed as follows.

First, the output of a transfer function can be displayed or at least conceptualized as presenting a response surface. The response surface graphically shows the relationship between variables in a transfer function. Consider FIG. 9. This figure shows a response surface 900 that is the result of a transfer function that maps an actionable X variable into at least one output dependent Y variable. (Although the Y variable may depend on plural actionable X variables, FIG. 9 shows the relationship between only one of the X variables and the Y variable, the other X variables being held constant.) The transfer function output is further computed for different slices of time, and, as such, time forms another variable in the transfer function. Of course, the shape of the response surface 900 shown in FIG. 9, and the collection of input assumptions, is merely illustrative. In cases where the transfer function involves more than three dimensions, the digital cockpit 104 can illustrate such additional dimensions by allowing the cockpit user to toggle between different graphical presentations that include different respective selections of variables assigned to axes, or by using some other graphical technique. Arrow 906 represents a mechanism for allowing a cockpit user to rotate the response surface 900 in any direction to view the response surface 900 from different vantage points. This feature will be described in greater detail in the Section E below.

As shown in FIG. 9, the response includes a relatively flat portion, such as portion 902, as well as another portion 904 that rapidly changes. For instance, in the flat portion 902, the output Y variables do not change with changes in the actionable X variable or with the time value. In contrast, the rapidly changing portion 904 includes a great deal of change as a function of both the X variable and the time value. Although not shown, other response surfaces may contain other types of rapidly changing portions, such as discontinuities, etc. In addition to differences in rate of change, the portion 902 is linear, whereas the portion 904 is non-linear. Nonlinearity adds an extra element of complexity to portion 904 compared to portion 902.

The digital cockpit 104 takes the nature of the response surface 900 into account when deciding what calculations to perform. For instance, the digital cockpit 104 need not perform fine-grained analysis for the flat portion 902 of FIG. 9, since results do not change as a function of the input variables for this portion 902. It is sufficient to perform a few calculations in this flat portion 902, that is, for instance, to determine the output Y variables representative of the flat surface in this portion 902. On the other hand, the digital cockpit 104 will make relatively fine-grained pre-calculation for the portion 904 that rapidly changes, because a single value in this region is in no way representative of the response surface 900 in general. Other regions in FIG. 9 have a response surface that is characterized by some intermediary between flat portion 902 and rapidly changing portion 904 (for instance, consider areas 908 of the response surface 900). Accordingly, the digital cockpit 104 will provide some intermediary level of pre-calculation in these areas, the level of pre-calculation being a function of the changeability of the response surface 900 in these areas. More specifically, in one case, the digital cockpit 104 can allocate discrete levels of analysis to be performed for different portions of the response surface 900 depending on whether the rate of change in these portions falls into predefined ranges of variability. In another case, the digital cockpit 104 can smoothly taper the level of analysis to be performed for the response surface 900 based on a continuous function that maps surface variability to levels that define the graininess of computation to be performed.

One way to assess the changeability of the response surface 900 is to compute a partial derivative of the response surface 900 (or a second derivative, third derivative, etc.). A derivative of the response surface 900 will provide an indication of the extent to which the response surface changes.

More specifically, in one exemplary implementation, the preloading logic 230 shown in FIG. 2 can perform pre-calculation in two phases. In a first phase, the preloading logic 230 probes the response surface 900 to determine the portions in the response surface 900 where there is a great amount of change. The preloading logic 230 can perform this task by selecting samples from the response surface 900 and determining the rate of range for those samples (e.g., as determined by the partial derivative for those samples). In one case, the preloading logic 230 can select random samples from the surface 900 and perform analysis for these random samples. For instance, assume that the surface 900 shown in FIG. 9 represents a Y variable that is a function of three X variables (X₁, X₂, and X₃) (but only one of the X variables is assigned to an axis of the graph). In this case, the preloading logic 230 can probe the response surface 900 by randomly varying the variables X₁, X₂, and X₃, and then noting the rate of change in the response surface 900 for those randomly selected variables. In another case, the preloading logic 230 can probe the response surface 900 in an orderly way, for instance, by selecting sample points for investigation at regular intervals within the response surface 900. In the second phase, the preloading logic 230 can revisit those portions of the response surface 900 that were determined to have high sensitivity. In the manner described above, the preloading logic 230 can perform relatively fine-grained analysis for those portions that are highly sensitive to change in input variables, and relatively “rough” sampling for those portions that are relatively insensitive to change in input variables.

Other criteria can be used to assess the nature and scope of the pre-calculations that should be performed. For instance, there may be a large amount of empirical business information that has a bearing on the pre-calculations that are to be made. For instance, empirical knowledge collected from a particular business sector may indicate that this business sector is commonly concerned with particular kinds of questions that warrant the generation of corresponding what-if analyses. Further, the empirical knowledge may provide guidance on the kinds of ranges of input variables that are typically used in exploring the behavior of the particular business sector. Still further, the empirical knowledge may provide insight regarding the dependencies in input variables. All of this information can be used to make reasonable projections regarding the kinds of what-if cases that the cockpit user 138 may want to run in the future. In one implementation, human business analysts can examine the empirical data to determine what output results to pre-calculate. In another implementation, an automated routine can be used to automatically determine what output results to pre-calculate. Such automated routines can use rule-based if-then logic, statistical analysis, artificial intelligence, neural network processing, etc.

In another implementation, a human analyst or automated analysis logic can perform pre-analysis on the response surface to identify the portions of the response surface that are particularly “desirable.” As discussed in connection with FIG. 5, a desirable portion of the response surface can represent a portion that provides a desired output result (e.g., a desired Y value), coupled with desired robustness. An output result may be regarded as robust when it is not unduly sensitive to change in input assumptions, and/or when it provides a satisfactory level of confidence associated therewith. The digital cockpit 104 can perform relatively fine-grained analyses for these portions, as it is likely that the cockpit user 138 will be focusing on these portions to determine the optimal performance of the business.

Still additional techniques can be used to determine what output results to calculate in advance.

In addition to pre-calculating output results, or instead of pre-calculating output results, the digital cockpit 104 can determine whether a general model that describes a response surface can be simplified by breaking it into multiple transfer functions that can be used to describe the component parts of the response surface. For example, consider FIG. 9 once again. As described above, the response surface 900 shown there includes a relatively flat portion 902 and a rapidly changing portion 904. Although an overall mathematical model may (or may not) describe the entire response surface 900, it may be the case that different transfer functions can also be derived to describe its flat portion 902 and rapidly changing portion 904. Thus, instead of, or in addition to, pre-calculating output results, the digital cockpit 104 can also store component transfer functions that can be used to describe the response surface's 900 distinct portions. During later use, a cockpit user may request an output result that corresponds to a part of the response surface 900 associated with one of component transfer functions. In that case, the digital cockpit 104 can be configured to use this component transfer function to calculate the output results. The above described feature has the capacity to improve the response time of the digital cockpit 104. For instance, an output result corresponding to the flat portion 902 can be calculated relatively quickly, as the transfer function associated with this region would be relatively straightforward, while an output result corresponding to the rapidly changing portion 904 can be expected to require more time to calculate. By expediting the computations associated with at least part of the response surface 900, the overall or average response time associated with providing results from the response surface 900 can be improved (compared to the case of using a single complex model to describe all portions of the response surface 900). The use of a separate transfer function to describe the flat portion 902 can be viewed as a “shortcut” to providing output results corresponding to this part of the response surface 900. In addition, providing separate transfer functions to describe the separate portions of the response surface 900 may provide a more accurate modeling of the response surface (compared to the case of using a single complex model to describe all portions of the response surface 900).

Finally, as previously discussed, the database 234 can also store output results that reflect analyses previously requested by the cockpit user 138 or automatically generated by the digital cockpit 104. For instance, in the past, the cockpit user 138 may have identified one or more case scenarios pertinent to a business environment prevailing at that time. The digital cockpit 104 generated output results corresponding to these case scenarios and archived these output results in the database 234. The cockpit user 138 can retrieve these archived output results at a later time without incurring the delay that would be required to recalculate these results. For instance, the cockpit user 138 may want to retrieve the archived output results because a current business environment resembles the previous business environment for which the archived business results were generated, and the cockpit user 138 wishes to explore the pertinent analysis conducted for this similar business environment. Alternatively, the cockpit user 138 may wish to simply further refine the archived output results.

FIG. 10 provides a flowchart of a process 1000 which depicts a sequence of steps for performing pre-calculation. The flowchart is modeled after the organization of steps in FIG. 4. Namely, the left-most series 1002 of steps pertains to the collection of data, and the right-most series 1004 of steps refers to operations performed when the user makes a request via the digital cockpit 104. The middle series 1006 of steps describe the pre-calculation of results.

To begin with, step 1008 describes a process for collecting data from the business processes, and storing such data in a historical database 1010, such as the data warehouse 208 of FIG. 2. In step 1012, the digital cockpit 104 pre-calculates results. The decisions regarding which results to pre-calculate can be based on the considerations described above, or other criteria. The pre-calculated results are stored in the pre-loaded results database 234 (also shown in FIG. 2). In addition, or in the alternative, the database 234 can also store separate transfer functions that can be used to describe component parts of a response surface, where at least some of the transfer functions allow for the expedited delivery of output results upon request for less complex parts of the response surface. Alternatively, step 1012 can represent the calculation of output results in response to an express request for such results by the cockpit user 138 in a prior analysis session, or in response to the automatic generation of such results in a prior analysis session.

In step 1014, the cockpit user 138 makes a request for a specific analysis. This request may involve inputting a case assumption using an associated permutation of actionable X variables via the cockpit interface mechanisms 318, 320, 322 and 324. In step 1016, the digital cockpit 104 determines whether the requested results have already been calculated off-line (or during a previous analysis session). This determination can be based on a comparison of the conditions associated with the cockpit user's 138 request with the conditions associated with prior requests. In other words, generically speaking, conditions A, B, C, . . . N may be associated with the cockpit user's 138 current request. Such conditions may reflect input assumptions expressly defined by the cockpit user 138, as well as other factors pertinent to the prevailing business environment (such as information regarding the external factors impacting the business that are to be considered in formulating the results), as well as other factors. These conditions are used as a key to search the database 234 to determine whether those conditions served as a basis for computing output results in a prior analysis session. Additional considerations can also be used in retrieving pre-calculated results. For instance, in one example, the database 234 can store different versions of the output results. Accordingly, the digital cockpit 104 can use such version information as one parameter in retrieving the pre-calculated output results.

In another implementation, step 1016 can register a match between currently requested output results and previously stored output results even though there is not an exact correspondence between the currently requested output results and previously stored output results. In this case, step 1016 can make a determination of whether there is a permissible variance between requested and stored output results by determining whether the input conditions associated with an input request are “close to” the input conditions associated with the stored output results. That is, this determination can consist of deciding whether the variance between requested and stored input conditions associated with respective output results is below a predefined threshold. Such a threshold can be configured to vary in response to the nature of the response surface under consideration. A request that pertains to a slowly changing portion of the response surface might tolerate a larger deviation between requested and stored output results compared to a rapidly changing portion of the response surface.

If the results have not been pre-calculated, then the digital cockpit 104 proceeds by calculating the results in a typical manner (in step 1018). This may involve processing input variables through one or more transfer functions to generate one or more output variables. In performing this calculation, the digital cockpit 104 can pull from information stored in the historical database 1010.

However, if the digital cockpit 104 determines that the results have been pre-calculated, then the digital cockpit 104 retrieves and supplies those results to the cockpit user 138 (in step 1020). As explained, the pre-loading logic 230 of FIG. 2 can be used to perform steps 1012, 1016, and 1020 of FIG. 10

If the cockpit user 138 determines that the calculated or pre-calculated results are satisfactory, then the cockpit user 138 initiates do-what commands (in step 1022). As previously described, such do-what commands may involve transmitting instructions to various workers (as reflected by path 1024), transmitting instructions to various entities coupled to the Internet (as reflected by path 1026), or transmitting instructions to one or more processing engines, e.g., to change the stored parameters or other features of these engines (as reflected by path 1028).

The what-if calculation environment shown in FIG. 5 and FIG. 8 can benefit from the above-described pre-calculation of output results. For instance, pre-calculation can be used in the context of FIG. 5 to pre-calculate an output result surface for different permutations of the five assumption knobs (representing actionable X variables). Further, if it is determined that a particular assumption knob does not have much effect of the output response surface, then the digital cockpit 104 could take advantage of this fact by limiting the quantity of stored analysis provided for the part of the response surface that is associated with this lack of variability.

A procedure similar to that described above can be used in the case where a response surface is described using plural different component transfer functions. In this situation, step 1016 entails determining whether a user's request corresponds to a separately derived transfer function, such as a transfer function corresponding to the flat portion 902 shown in FIG. 9. If so, the digital cockpit 104 can be configured to compute the output result using this transfer function. If not, the digital cockpit 104 can be configured to compute the output result using a general model applicable to the entire response surface.

E. Visualization Functionality

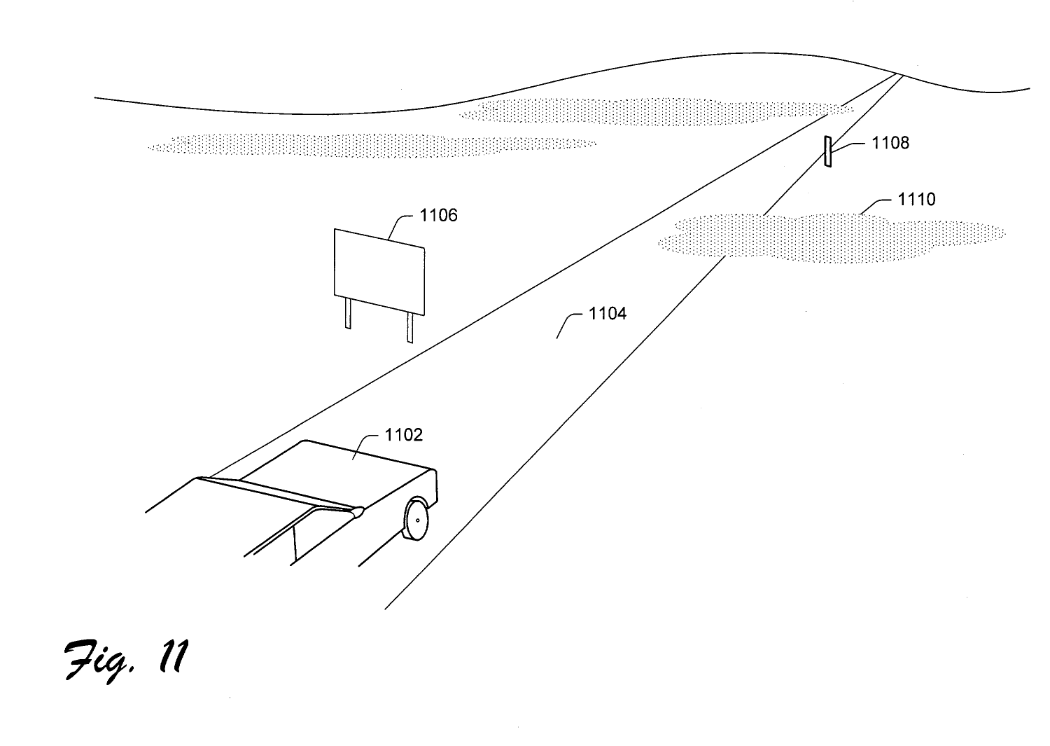

The analogy made between the digital cockpit 104 of a business and the cockpit of a vehicle extends to the “visibility” provided by the digital cockpit 104 of the business. Consider, for instance, FIG. 11, which shows an automobile 1102 advancing down a road 1104. The driver of the automobile 1102 has a relatively clear view of objects located close to the automobile, such as sign 1106. However, the operator may have a progressively dimmer view of objects located farther in the distance, such as mile marker 1108. This uncertainly regarding objects located in the distance is attributed to the inability to clearly discern such objects located in the distance. Also, a number of environmental factors, such as fog 1110 may obscure these distance objects (e.g., object 1108). In a similar manner, the operator of a business has a relatively clear understanding of events in the near future, but a progressively dimmer view of events that may happen in the distance future. And like a roadway 1104, there may be various conditions in the marketplace that “obscure” the visibility of the business as it navigates its way toward a desired goal.

Further, it will be appreciated from common experience that a vehicle, such as the automobile 1102, has inherent limitations regarding how quickly it can respond to hazards in its path. Like an automobile 1102, the business also can be viewed as having an inherently “sluggishness” to change. Thus, in the case of the physical system of the automobile 1102, we take this information into account in the manner in which we drive, as well as the route that we take. Similarly, the operator of a business can take the inherent sluggishness of the business into account when making choices regarding the operation of the business. For instance, the business leader will ensure that he or she has a sufficient forward-looking depth of view into the projected future of the business in order to safely react to hazards in its path. Forward-looking capability can be enhanced by tailoring the what-if capabilities of the digital cockpit 104 to allow a business leader to investigate different paths that the business might take. Alternatively, a business leader might want to modify the “sluggishness” of the business to better enable the business to navigate quickly and responsively around assessed hazards in its path. For example, if the business is being “operated” through a veritable fog of uncertainty, the prudent business leader will take steps to ensure that the business is operated in a safe manner in view of the constraints and dangers facing the business, such as by “slowing” the business down, providing for better visibility within the fog, installing enhanced breaking and steering functionality, and so on.

As appreciated by the present inventors, in order for the cockpit user 138 to be able to perform in the manner described above, it is valuable for the digital cockpit 104 to provide easily understood and intuitive visual information regarding the course of the business. It is further specifically desirable to present information regarding the uncertainty in the projected course of the business. To this end, this section provides various techniques for graphically conveying uncertainty in predicted cockpit results.

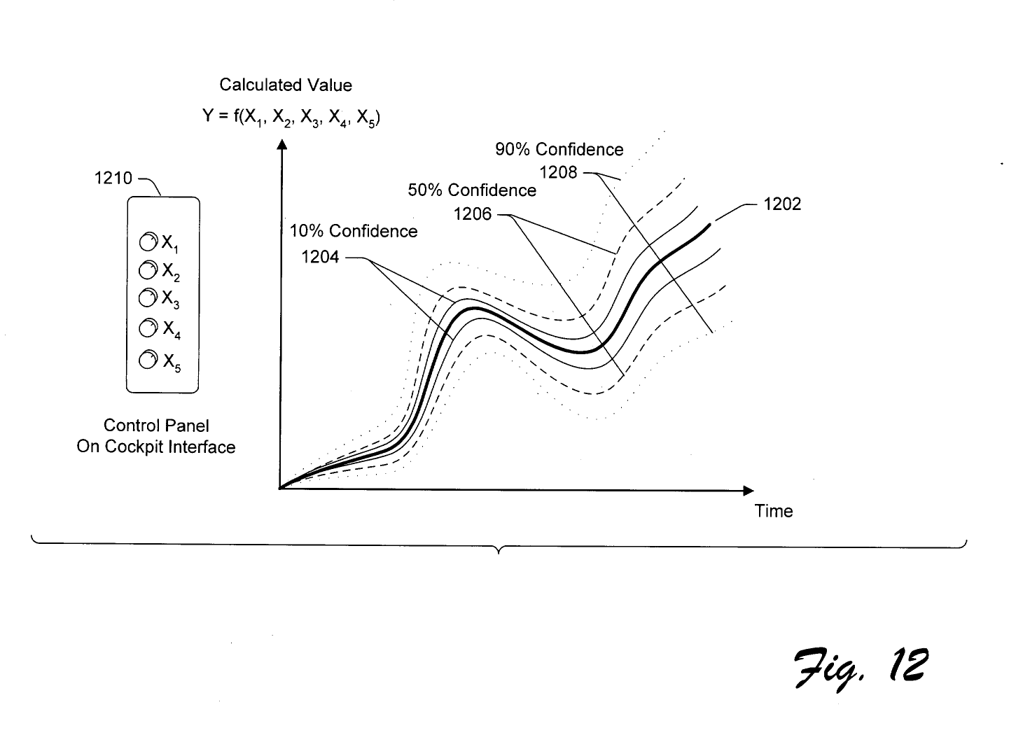

To begin with, consider FIG. 12. The output generated by a forward-looking model 136 will typically include some uncertainty associated therewith. This uncertainty may stem, in part, from the uncertainty in the input values that are fed to the model 136 (due to natural uncertainties regarding what may occur in the future). FIG. 12 shows a two-dimensional graph that illustrates the uncertainties associated with the output of forward-looking model 136. The vertical axis of the graph represents the output of an exemplary forward-looking model 136, while the horizontal axis represents time. Curve 1202 represents a point estimate response output of the model 136 (e.g., the “calculated value”) as a function of time. Confidence bands 1204, 1206, and 1208 reflect the level of certainty associated with the response output 1202 of the model 136 at different respective confidence levels. For instance, FIG. 12 indicates that there is a 10% confidence level that future events will correspond to a value that falls within band 1204 (demarcated by two solid lines that straddled the curve 1202). There is a 50% confidence level that future events will correspond to a value that falls within band 1206 (demarcated by two dashed lines that straddled the curve 1202). There is a 90% confidence level that future events will correspond to a value that falls within band 1208 (demarcated by two outermost dotted lines that straddled the curve 1202). All of the bands (1204, 1206, 1208) widen as future time increases. Accordingly, it can be seen that the confidence associated with the model's 136 output decreases as the predictions become progressively more remote in the future. Stated another way, the confidence associated with a specific future time period will typically increase as the business moves closer to that time period.

The Y variable shown on the Y-axis in FIG. 12 can be a function of multiple X variables (a subset of which may be “actionable”). That is Y=f(X₁, X₂, X₃, . . . Xₙ). The particular distribution shown in FIG. 12 may reflect a constant set of X variables. That is, independent variables X₁, X₂, X₃, . . . Xₙ are held constant as time advances. However, one or more of the X variables can be varied through the use of the control window 316 shown in FIG. 3. A simplified representation of the control window 316 is shown as knob panel 1210 in FIG. 12. This exemplary knob panel 1210 contains five knobs. The digital cockpit 104 can be configured in such a manner that a cockpit user's 138 variation of one or more of these knobs will cause the shape of the curves shown in FIG. 12 to also change in dynamic lockstep fashion. Hence, through this visualization technique, the user can gain added insight into the behavior the model's transfer function.

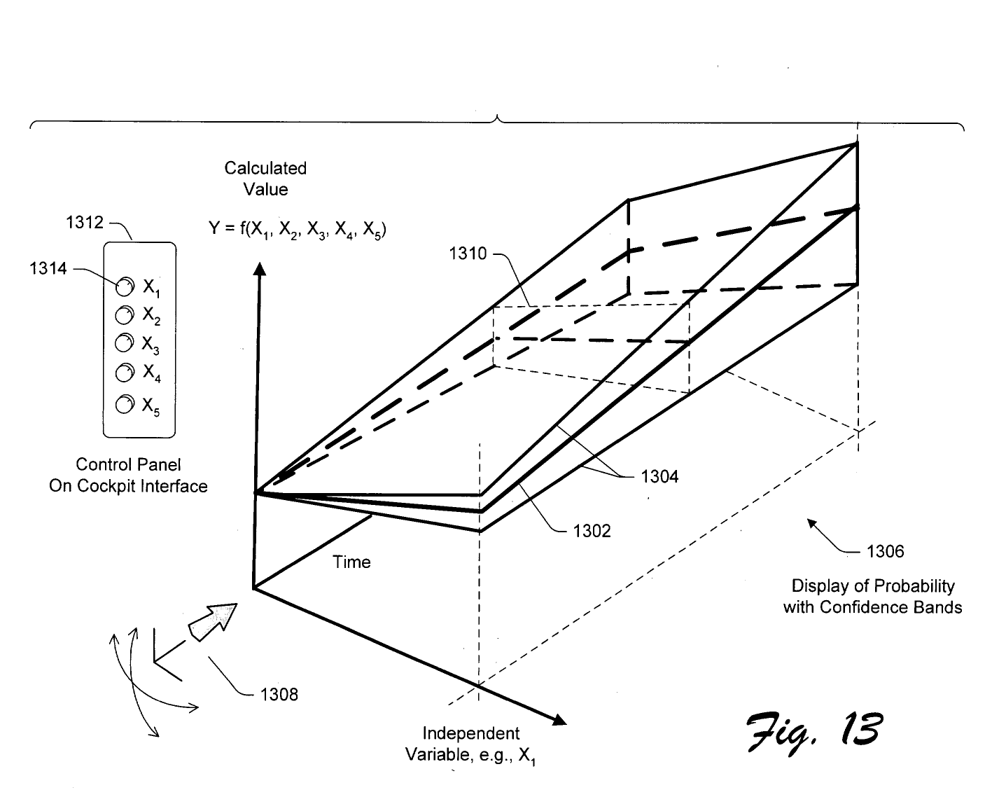

FIG. 12 is a two dimensional graph, but it is also possible to present the confidence bands shown in FIG. 12 in more than two dimensions. Consider FIG. 13, for instance, which provides confidence bands in a three-dimensional response surface. This graphs shows variation in a dependent calculated Y variable (on the vertical axis) based on variation in one of the actionable X variables (on the horizontal axis), e.g., X₁ in this exemplary case. Further, this information is presented for different slices of time, where time is presented on the z-axis.

More specifically, FIG. 13 shows the calculation of a response surface 1302. The response surface 1302 represents the output of a transfer function as a function of the X₁ and time variables. More specifically, in one exemplary case, response surface 1302 can represent one component surface of a larger response surface (not shown). Like the case of FIG. 12, the digital cockpit 104 computes a confidence level associated with the response surface 1302. Surface's 1304 represent the upper and lower bounds of the confidence levels. Accordingly, the digital cockpit 104 has determined that there is a certain percentage that the actual response surface that will be realized will lie within the bounds defined by surfaces 1304. Again, note that the confidence bands (1304) widen as a function of time, indicating that the predictions become progressively more uncertain as a function of forward-looking future time. To simplify the drawing, only one confidence band (1304) is shown in FIG. 13. However, like the case of FIG. 12, the three dimensional graph in FIG. 13 can provide multiple gradations of confidence levels represented by respective confidence bands. Further, to simplify the drawing, the confidence bands 1304 and response surface 1302 are illustrated as having a linear surface, but this need not be so.

The confidence bands 1304 which sandwich the response surface 1302 defines a three dimensional “object” 1306 that defines uncertainty associated with the business's projected course. A graphical orientation mechanism 1308 is provided that allows the cockpit user 138 to rotate and scale the object 1306 in any manner desired. Such a control mechanism 1308 can take the form of a graphical arrow that the user can click on and drag. In response, the digital cockpit 104 is configured to drag the object 1306 shown in FIG. 13 to a corresponding new orientation. In this manner, the user can view the object 1306 shown in FIG. 13 from different vantage points, as if the cockpit user 138 was repositioning their own self around an actual physical object 1306. This function can be implemented within the application logic 218 in the module referred to as display presentation logic 236. Alternatively, it can be implemented in code stored in the workstation 246. In any case, this function can be implemented by storing an n-dimensional matrix (e.g., a three-dimensional matrix) which defines the object 1306 with respect to a given reference point. A new vantage point from which to visualize the object 1306 can be derived by scaling and rotating the matrix as appropriate. This can be performed by multiplying the matrix describing the object 1306 by a transformation matrix, as is known in the art of three-dimensional graphics rendering.

The graphical orientation mechanisms also allows the user to slice the object 1306 to examine two dimensional slices of the object 1306, as indicated by the extraction of slice 1310 containing response surface 302.

Again, a knob panel 1312 is available to the cockpit user 138, which allows the cockpit user 128 to vary other actionable X variables that are not directly represented in FIG. 13 (that is, that are not directly represented on the horizontal axis). It is also possible to allow a cockpit user 138 to select the collection of variables that will be assigned to the axes shown in FIG. 13. In the present exemplary case, the horizontal axis has been assigned to the actionable X₁ variable. But it is possible to assign another actionable X variable to this axis.

The confidence bands shown in FIGS. 12 and 13 can be graphically illustrated on the cockpit interface 134 using different techniques. For instance, the digital cockpit 104 can assign different colors or gray scales, colors, densities, patterns, etc. to different respective confidence bands.

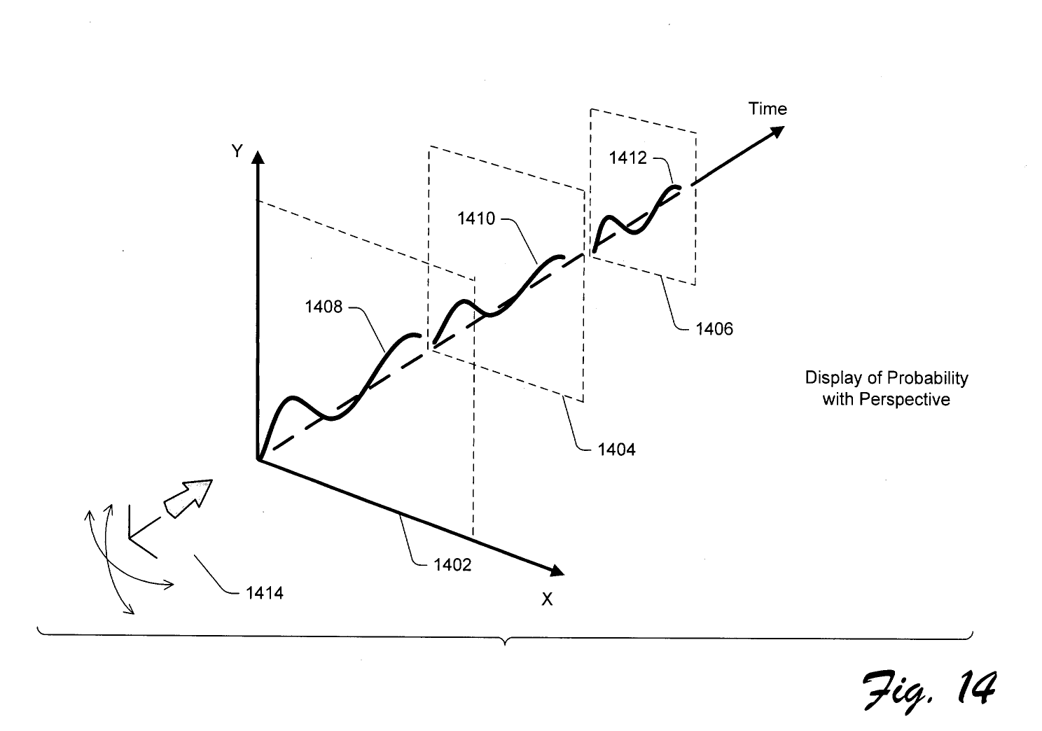

FIGS. 14-17 show other techniques for representing the uncertainty associated with the output results of predictive models 136. More specifically, to facilitate discussion, each of FIGS. 14-17 illustrates a single technique for representing uncertainty. However, the cockpit interface 134 can use two or more of the techniques in a single output presentation to further highlight the uncertainty associated with the output results.

To begin with, instead of confidence bands, FIG. 14 visually represents different levels of uncertainty by changing the size of the displayed object (where an object represents an output response surface). This technique simulates the visual uncertainty associated with an operator's field of view while operating a vehicle (e.g., as in the case of FIG. 11). More specifically, FIG. 14 simplifies the discussion of a response surface by representing only three slices of time (1402, 1404, and 1406). Object 1408 is displayed on time slice 1402, object 1410 is displayed on response surface 1404, and object 1412 is displayed on response surface 1406. As time progresses further into the future, the uncertainty associated with model 136 increases. Accordingly, object 1408 is larger than object 1410, and object 1412 is larger than object 1410. Although only three objects (1408, 1410, . . . 1412) are shown, many more can be provided, thus giving an aggregate visual appearance of a solid object (e.g., a solid response surface). Viewed as a whole, this graph thus simulates perspective effect in the physical realm, where an object at a distance is perceived as “small,” and hence it can be difficult to discern. A cockpit user can interpret the presentation shown in FIG. 14 in a manner analogous to assessments made by an operator while operating a vehicle. For example, the cockpit user may note that there is a lack of complete information regarding objects located at a distance because of the small “size” of these objects. However, the cockpit user may not regard this shortcoming as posing an immediate concern, as the business has sufficient time to gain additional information regarding the object as the object draws closer and to subsequently take appropriate corrective action as needed.

It should be noted that objects 1408, 1410, and 1412 are denoted as relatively “sharp” response curves. In actuality, however, the objects may reflect a probabilistic output distribution. The sharp curves can represent an approximation of the probabilistic output distribution, such as the mean of this distribution. In the manner described above, the probability associated with the output results is conveyed by the size of the objects rather than a spatial distribution of points.

Arrow 1414 again indicates that the cockpit user is permitted to change the orientation of the response surface shown in FIG. 14. Further, the control window 316 of FIG. 13 gives the cockpit user flexibility in assigning variables to different axes shown in FIG. 14.

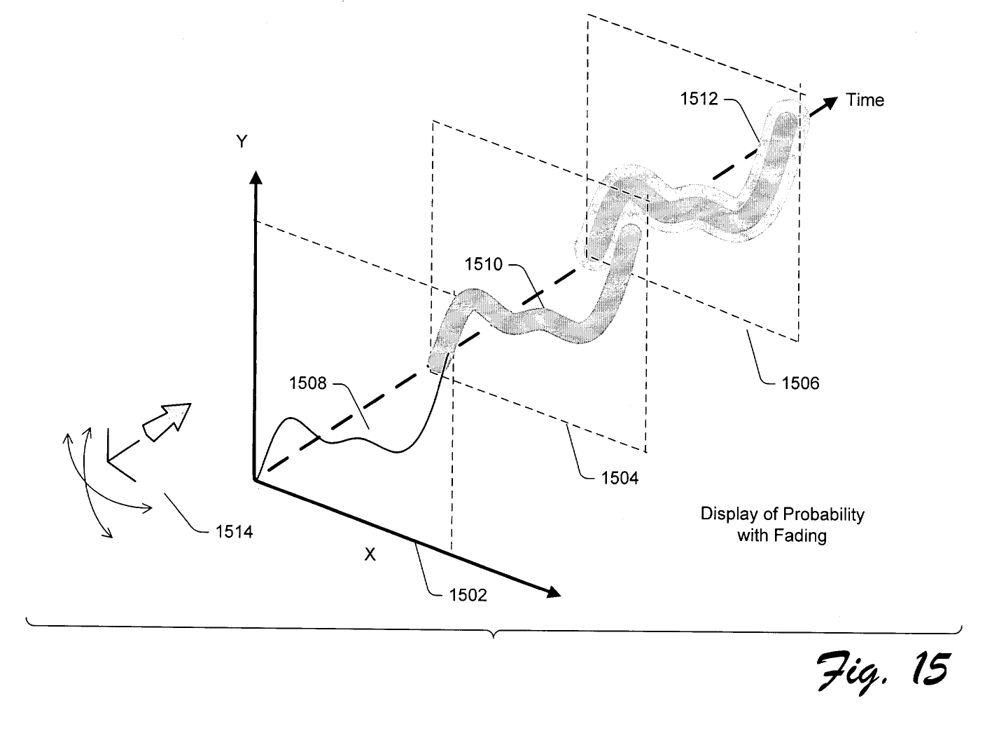

FIG. 15 provides another alternative technique for representing uncertainty in a response surface, that is, by using display density associated with the display surface to represent uncertainty. Again, three different slices of time are presented (1502, 1504, and 1506). Object 1508 is displayed on time slice 1502, object 1510 is displayed on time slice 1504, and object 1512 is displayed on time slice 1506. As time progresses further into the future, the uncertainty associated with the model 136 output increases, and the density decreases in proportion. That is, object 1510 is less dense that object 1508, and object 1512 is less dense than object 1510. This has the effective of fading out objects that have a relatively high degree of uncertainty associated therewith.

Arrow 1514 again indicates that the cockpit user is permitted to change the orientation of the response surface shown in FIG. 15. Further, the control window 316 of FIG. 13 gives the cockpit user flexibility in assigning variables to different axes shown in FIG. 15.

Further, control window 316 of FIG. 13 can allow the user to vary the density associated with the output results, such as by turning a knob (or other input mechanism) that changes density level. This can have the effect of adjusting the contrast of the displayed object with respect to the background of the display presentation. For instance, assume that the digital cockpit 104 is configured to display only output results that exceed a prescribed density level. Increasing the density level offsets all of the density levels by a fixed amount, which results in the presentation of a greater range of density values. Decreasing the density levels offsets all of the density levels by a fixed amount, which results in the presentation of a reduced range of density values. This has the effect of making the aggregate response surface shown in FIG. 15 grow “fatter” and “thinner” as the density input mechanism is increased and decreased, respectively. In one implementation, each dot that make ups a density rendering can represent a separate case scenario that is run using the digital cockpit 104. In another implementation, the displayed density is merely representative of the probabilistic distribution of the output results (that is, in this case, the dots in the displayed density do not directly correspond to discrete output results).

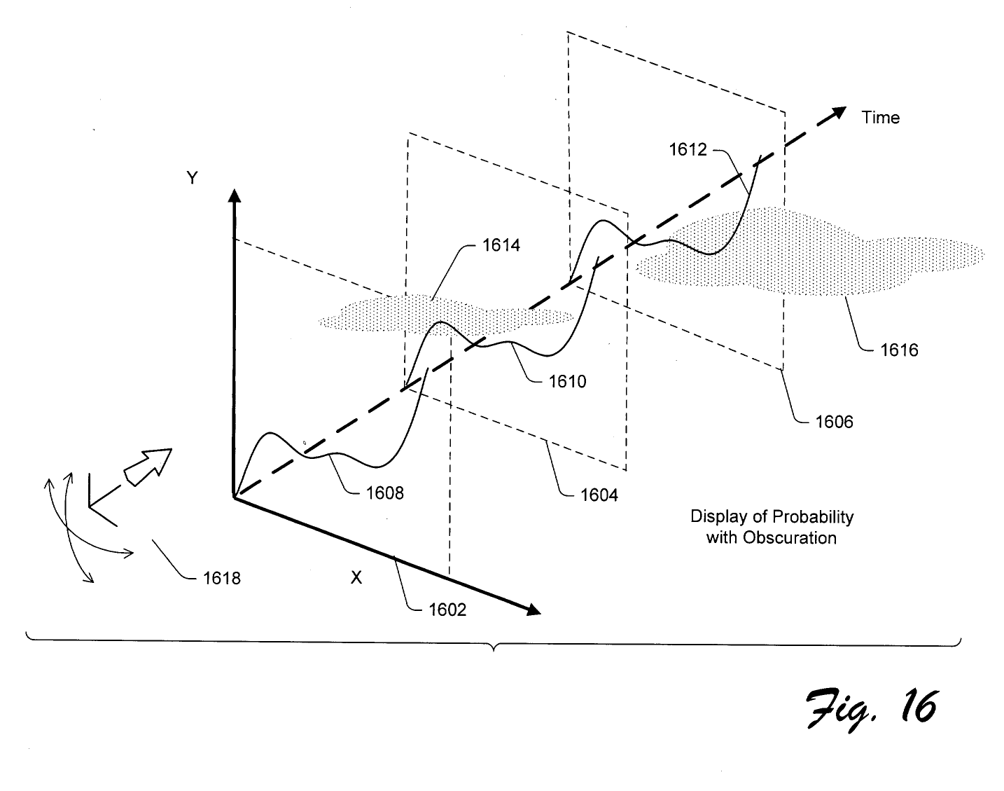

FIG. 16 provides another technique for representing uncertainty in a response surface, that is, by using obscuring fields to obscure objects in proportion to their uncertainty. Again, three different slices of time are presented (1602, 1604, and 1606). Object 1608 is displayed on time slice 1602, object 1610 is displayed on time slice 1604, and object 1612 is displayed on time slice 1606. As time progresses further into the future, the uncertainty associated with model 136 increases, and the obscuring information increases accordingly. That is, fields 1614 and 1616 generally represent obscuring information, generally indicative of fog, which partially obscures the clarity of visual appearance of objects 1610 and 1612, respectively. This has the effect of progressively concealing objects as the uncertainty associated with the objects increases, as if the objects were being progressively obscured by fog in the physical realm. In the manner described for FIG. 14, the relatively sharp form of the objects (1608, 1610, 1612) can represent the mean of a probabilistic distribution, or some other approximation of the probabilistic distribution.

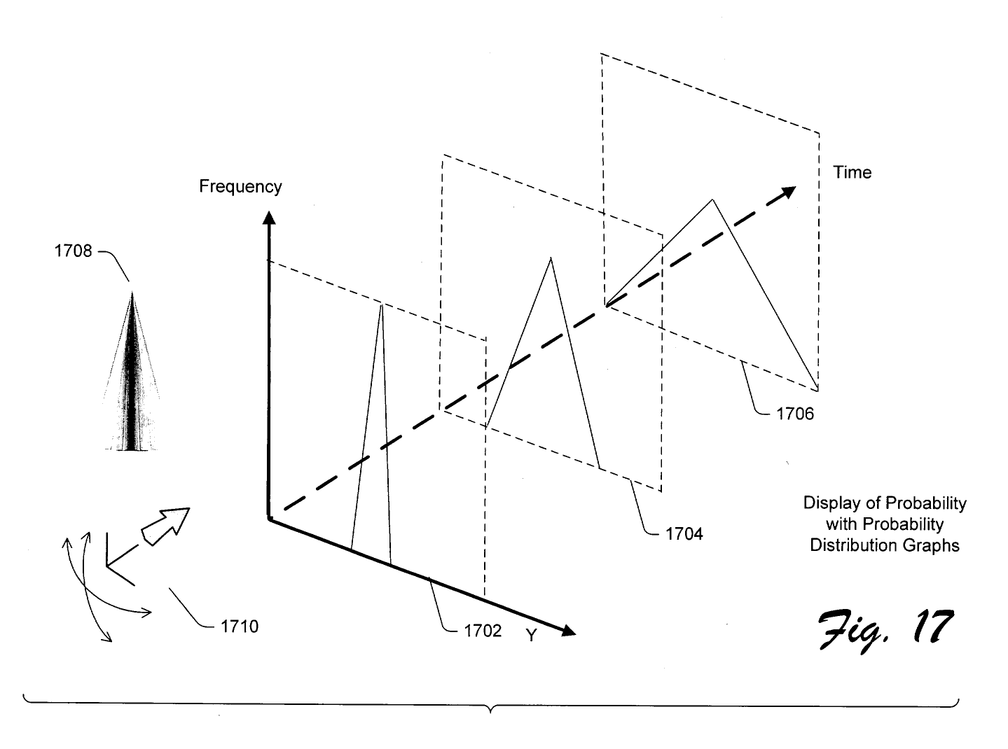

FIG. 17 provides yet another alternative technique for representing uncertainty in a response surface, that is, by using a sequence of probability distributions associated with different time slices to represent uncertainty (such as frequency count distributions or mathematically computed probability distributions). Again, three different slices of time are presented (1702, 1704, and 1706). The horizontal axis of the graph represents the result calculated by the model 136 (e.g., variable Y), and the vertical axis represents the probability associated with the calculated value. As time progresses further into the future, the uncertainty associated with model 136 increases, which is reflected in the sequence of probability distributions presented in FIG. 17. Namely, the distribution shown on slice 1702 has a relatively narrow distribution, indicating that there is a relative high probability that the calculated result lies in a relatively narrow range of values. The distribution shown on slice 1704 has broader distribution than the distribution on slice 1702. And the distribution on slice 1706 has an even broader base distribution than the distribution on slice 1704. For all three, if the distributions represent mathematically computed probability distributions, the area under the distribution curve equals the value 1.

The distributions shown in FIG. 17 can also be shaded (or, generally, colored) in a manner that reflects the probability values represented by the distribution. Note exemplary shading scheme 1708, which can be used in any of the distributions shown in FIG. 17. As indicated there, the peak (center) of the distribution has the highest probability associated therewith, and is therefore assigned the greatest gray-scale density (e.g., black). The probability values decrease on either side of the central peak, and thus, so do the density values of these areas. The density values located in the base corners of the shading scheme 1708 are the smallest, e.g., lightest. The shading scheme 1708 shown in FIG. 17 will have a similar effect to FIG. 15. As uncertainty increases, objects will become more and more diffuse, thus progressively blending into the background of the display. As the uncertainty decreases, objects will become more concentrated, and will thus have a darkened appearance on the display.

Arrow 1710 again indicates that the cockpit user is permitted to change the orientation of the response surface shown in FIG. 17. Further, the control window 316 of FIG. 13 gives the cockpit user flexibility in assigning variables to different axes shown in FIG. 17.

In each of FIGS. 12-17, it was assumed that the origins of the respective graphical presentations correspond to a time of t=0, which reflects the present time, that is, which reflects the time at which the analysis was requested. In one implementation, the presentations shown in FIGS. 12-17 can be automatically updated as time progresses, such that t=0 generally corresponds to the current time at which the presentation is being viewed. The output results shown in FIGS. 12-17 can also dynamically change in response to updates in other parameters that have a bearing in the shape of the resultant output surfaces.

In another implementation, the presentations shown in FIGS. 12-17 can provide information regarding prior (i.e., historical) periods of time. For instance, consider the exemplary case of FIG. 15, which shows increasing uncertainty associated with output results by varying the density level of the output results. Assume that time slice 1502 reflects the time at which the cockpit user 138 requested the digital cockpit 104 to generate the forecast shown in FIG. 15, that is, the prevailing present time when cockpit user 138 made the request. Assume that time slice 1506 represents a future time relative to the time of the cockpit user's 138 request, such as six months after the time at which the output forecast was requested. Subsequent to the generation of this projection, the actual course that the business takes “into the future” can be mapped on the presentation shown in FIG. 15, for instance, by superimposing the actually measured metrics on the presentation shown in FIG. 15. This will allow the cockpit user 138 to gauge the accuracy of the forecast originally generated at time slice 1502. For instance, when the time corresponding to time slice 1506 actually arrives, the cockpit user 138 can superimpose a response surface which illustrates what actually happened relative to what was projected to happen.

Any of the presentations shown in this section can also present a host of additional information that reflects the events that have transpired within the business. For instance, the cockpit user 138 may have made a series of changes in the business based on his or her business judgment, or based on analysis performed using the digital cockpit 104. The presentations shown in FIGS. 12-17 can map a visual indication of actual changes that were made to the business with respect to what actually happened in the business in response thereto. On the basis of this information, the cockpit user 138 can gain insight into how the do-what commands have affected the business. That is, such a comparison provides a vehicle for gaining insight as to whether the changes achieve a desired result, and if so, what kind of time lag exists between the input of do-what commands and the achievement of the desired result.

Further, any of the above-described presentations can also provide information regarding the considerations that played a part in the cockpit user's 138 selection of particular do-what commands. For instance, at a particular juncture in time, the cockpit user 138 may have selected a particular do-what command in response to a consideration of prevailing conditions within the business environment, and/or in response to analysis performed using the digital cockpit 104 at that time. The presentations shown in FIGS. 12-17 can provide a visual indication of this information using various techniques. For instance, the relevant considerations surrounding the selection of do-what commands can be plotted as a graph in the case where such information lends itself to graphical representation. In an alternative embodiment, the relevant considerations surrounding the selection of do-what commands can be displayed as textual information, or some combination of graphical and textual information. For instance, in one illustrative example, visual indicia (e.g., various symbols) can be associated with the time slices shown in FIGS. 13-17 that denotes the junctures in time when do-what commands where transmitted to the business. The digital cockpit 104 can be configured such that clicking on the time slice or its associated indicia prompts the digital cockpit 104 to provide information regarding the considerations that played a part in the cockpit user 138 selecting that particular do-what command. For instance, suppose that the cockpit user 138 generated a particular depiction of a response surface generated by a particular version of a model, and that this response surface was instrumental in deciding to make a particular change within the business. In this case, the digital cockpit 104 can be configured to reproduce this response surface upon request. Alternatively, or in addition, such information regarding the relevant considerations can be displayed in textual form, that is, for instance, by providing information regarding the models that were run that had a bearing on the cockpit user's 138 decisions, information regarding the input assumptions fed to the models, information regarding the prevailing business conditions at the time the cockpit user 138 made his or her decisions, information regarding what kinds and depictions of output surfaces the cockpit user 138 may have viewed, and so on.

In general terms, the above-described functionality provides a tool which enables the cockpit user 138 to track the effectiveness of their control of the business, and which enables the cockpit user 138 to better understand the factors which have lead to successful and unsuccessful decisions. The above discussion referred to tracking changes made by a human cockpit user 138 and the relevant considerations that may have played a part in the decisions to make these changes; however, similar tracking functionality can be provided in the case where the digital cockpit 104 automatically makes changes to the business based on automatic control routines.

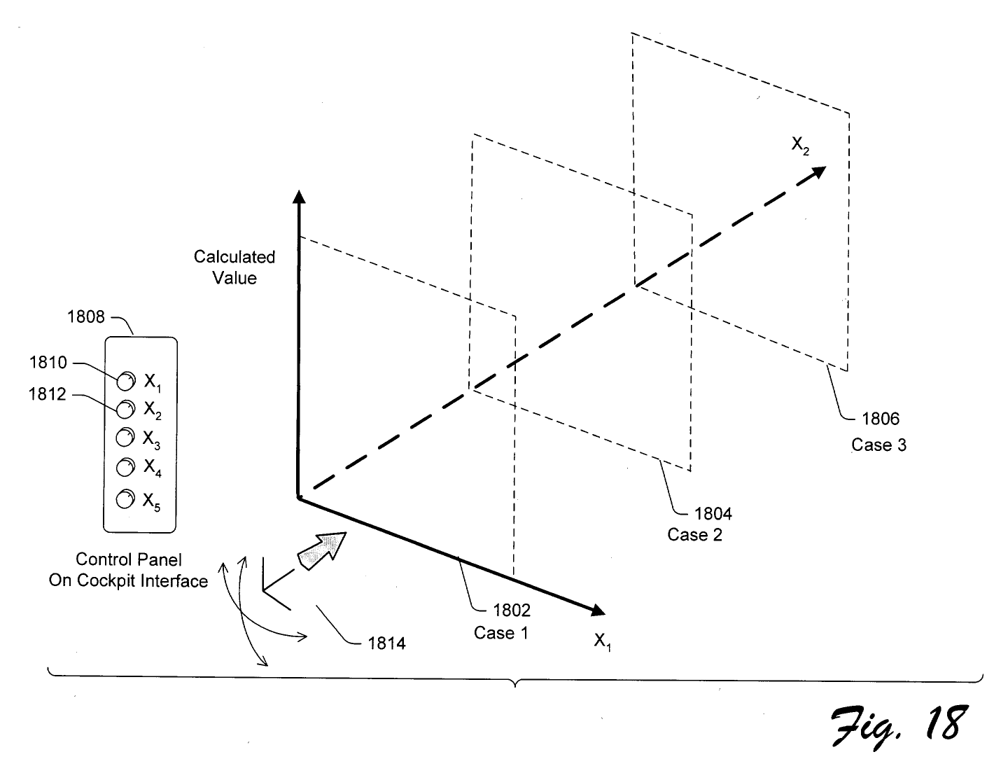

In each of FIGS. 12-17, the uncertainty associated with the output variable was presented with respect to time. However, uncertainty can be graphically represented in graphs that represent any combination of variables other than time. For instance, FIG. 18 shows the presentation of a calculated value on the vertical axis and the presentation of actionable X₁ variable on the horizontal axis. Instead of time assigned to the z-axis, this graph can assign another variable, such as actionable X₂ variable, to the z-axis. Accordingly, different slices in FIG. 18 can be conceptualized as presenting different what-if cases (involving different permutations of actionable X variables). Any of the graphical techniques described in connection with FIGS. 12-17 can be used to represent uncertainty in the calculated result in the context of FIG. 18.

Knob panel 1808 is again presented to indicate that the user has full control over the variables assigned to the axes shown in FIG. 18. In this case, knob 1810 has been assigned to the actionable X₁ variable, which, in turn, has been assigned to the x-axis in FIG. 18. Knob 2 1812 has been assigned to the actionable X₂ variable, which has been assigned to the z-axis. Further, even though the other knobs are not directly assigned to axes, the cockpit user 138 can dynamically vary the settings of these knobs and watch, in real time, the automatic modification of the response surface. The cockpit user can also be informed as to which knobs are not assigned to axes by virtue of the visual presentation of the knob panel 1808, which highlights the knobs which are assigned to axes.

Arrow 1814 again indicates that the cockpit user is permitted to change the orientation of the response surface that is displayed in FIG. 18.

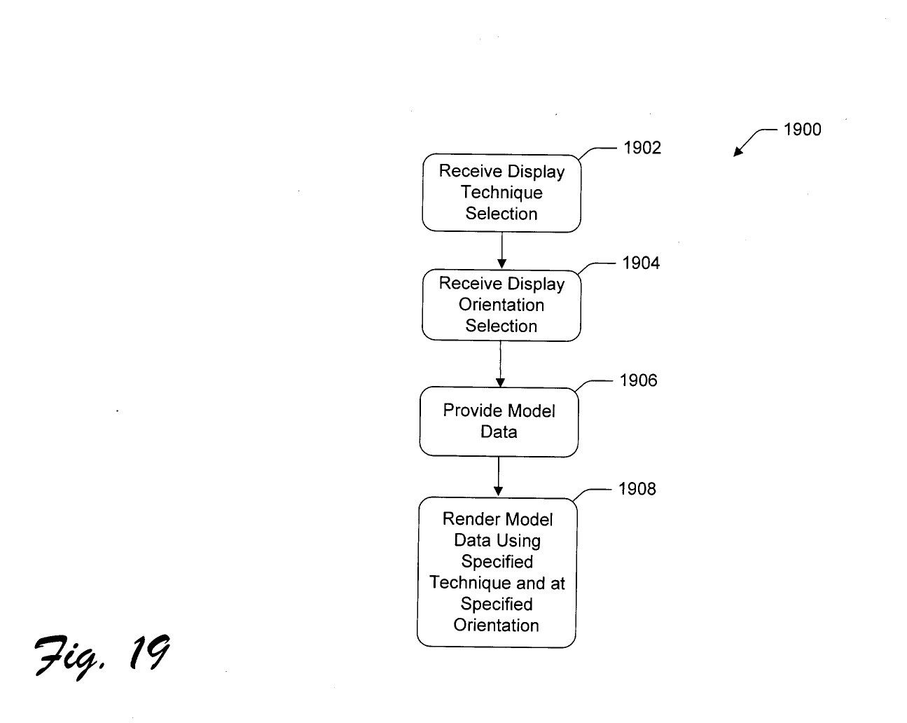

FIG. 19 shows a general method 1900 for presenting output results to the cockpit user 138. Step 1902 includes receiving the cockpit user's 138 selection of a technique for displaying output results. For instance, the cockpit interface 134 can be configured to present the output results to the cockpit user 138 using any of the techniques described in connection with FIGS. 12-18, as well as additional techniques. Step 1902 allows the cockpit user 138 to select one or more of these selection techniques.

Step 1904 entails receiving a cockpit user 138's selection regarding the vantage point from which the output results are to be displayed. Step 1904 can also entail receiving the user's instructions regarding what portions of the output result surface should be displayed (e.g., what slices of the output surface should be displayed.

Step 1906 involves generating the response surface according to the cockpit user 138's instructions specified in steps 1902 and 1904. And step 1908 involves actually displaying the generated response surface.

F. Conclusion

A digital cockpit 104 has been described that includes a number of beneficial features, including what-if functionality, do-what functionality, the pre-calculation of output results, and the visualization of uncertainty in output results.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method for performing and acting on what-if forecasts in a business that includes multiple interrelated business processes, comprising:
providing a business information and decisioning control system to a user, wherein the business information and decisioning control system is coupled to the interrelated business processes, further wherein the business information and decisioning control system includes a business system user interface that includes plural input mechanisms;
receiving the user's selection of an input setting made using at least one of the plural input mechanisms, the input setting defining a what-if case scenario;
performing a forecast based on the what-if case scenario using a predictive model provided by the business information and decisioning control system to generate an output result, the output result forecasting an effect that the what-if case scenario will have on the interrelated business processes;
presenting the output result to the user; and
receiving the user's selection of a command via the business system user interface, wherein the command prompts at least one of the interrelated business processes to make a change representative of the input setting.

2. A method according to claim 1, wherein the plurality of input mechanisms detect the user's input setting via tactile-related input detection, key actuation, sound recognition, motion detection, or biofeedback input detection.

3. A method according to claim 1, wherein the business system user interface includes:
a first display field for presenting information regarding what has happened in the business in the past;
a second display field for presenting information regarding what is presently happening in the business; and
a third display field for presenting information regarding what is projected to happen in the business in the future.

4. A method according to claim 1, wherein the user's selection of the input setting defines at least one of:
a setting pertaining to a number of assets involved in at least one of the interrelated business processes;
a setting pertaining to an amount of time that the assets are allocated to a task performed in at least one of the interrelated business processes; and
a setting pertaining to an amount of rework involved in revising a result provided by at least one of the interrelated business processes.

5. A method according to claim 1, wherein the predictive model generates the output result based, at least in part, on historical data collected from the interrelated business processes.

6. A method according to claim 5, further including collecting the historical data from the interrelated business processes, transforming the historical data into a designated form, and storing the transformed data in a database for use by the business information and decisioning control system, wherein the database is coupled to the business information and decisioning control system.

7. A method according to claim 5, wherein the historical data is collected from at least one source that is internal to the business, and at least one source that is external to the business.

8. A method according to claim 1, wherein the predictive model generates the output result using a transfer function, wherein the transfer function maps at least one independent input variable to the output result.

9. A method according to claim 8, wherein at least one of the interrelated business processes can be modeled using the same transfer function used to provide the forecast in the business information and decisioning control system.

10. A method according to claim 1, wherein the business information and decisioning control system includes a plurality of models, and further including automatically selecting a predictive model from the plurality of models based on an assessment performed by the business information and decisioning control system.

11. A method according to claim 1, wherein the steps of receiving the user's selection of an input setting, performing a forecast, and presenting the output result are performed multiple times until the user is satisfied with the output result.

12. A method according to claim 1, wherein the output result pertains to at least one of:
a financial metric pertaining to a forecasted financial performance of the business;
a resource-related metric pertaining to resources used in the business or provided by the business; and
a cycle time pertaining to a time required to complete one or more tasks within the interrelated business processes.

13. A method according to claim 1, wherein the step of presenting the output result includes displaying a visual representation of the output result to the user.

14. A method according to claim 13, wherein the visual representation of the output result includes an n-dimensional plot that maps the output result as a function of at least one independent variable.

15. A method according to claim 13, wherein the visual representation of the output results includes an n-dimensional plot that maps the output result as a function of time.

16. A method according to claim 13, wherein the visual representation of the output result reflects a probabilistic response surface that provides an indication of a level of statistical confidence associated with the output result.

17. A method according to claim 13, wherein the visual representation of the output result is dynamically updated in response to changes in at least one variable that has a bearing on the output result.

18. A method according to claim 13, wherein the visual representation of the output result also provides information regarding a measured result that reflects an actual course of the business for comparison with the output result.

19. A method according to claim 18, further including automatically comparing the output result to the measured result based on at least one comparison factor.

20. A method according to claim 1, wherein the business pertains to a services-related business or a manufacturing business.

21. A computer-readable medium including instructions for carrying out the method of claim 1.

22. A method for using a business information and decisioning control system to perform what-if forecasts in a business that includes multiple interrelated business processes, wherein the business information and decisioning control system is coupled to the interrelated business processes, comprising:
activating a business system user interface provided by the business information and decisioning control system, the business system user interface including plural input mechanisms;
making an input setting using at least one of the plural input mechanisms, the input setting defining a what-if case scenario, the what-if case scenario prompting the business information and decisioning control system to generate an output result using a predictive model provided by the business information and decisioning control system, the output result forecasting an effect that the what-if case scenario will have on the interrelated business processes;
analyzing the output result to determine whether the forecasted effect on the interrelated business processes is satisfactory;
if the output result is deemed satisfactory, entering a command via the business system user interface, wherein the command prompts at least one of the interrelated business processes to make a change representative of the input setting; and
if the output result is deemed unsatisfactory, repeating the making and analyzing steps.

23. A business information and decisioning control system for performing and acting on what-if forecasts in a business that includes multiple interrelated business processes, comprising:
a control module configured to receive information provided by the interrelated business processes, and to provide commands to the interrelated business processes;
a business system user interface, coupled to the control module, configured to allow a user to interact with the control module, the business system user interface including plural input mechanisms for receiving instructions from the user;
wherein the control module includes:
logic configured to receive the user's selection of an input setting made using at least one of the plural input mechanisms, the input setting defining a what-if case scenario;
logic configured to perform a forecast based on the what-if case scenario using a predictive model to generate an output result, the output result forecasting an effect that the what-if case scenario will have on the interrelated business processes;
logic configured to present the output result to the user; and
logic configured to receive the user's selection of a command via the business system user interface and to transmit instructions to at least one of the interrelated business processes based on the command, the instructions prompting the at least one of the interrelated business processes to make a change representative of the input setting.

24. A business information and decisioning control system according to claim 23, wherein the control module is implemented in a server, and the business system user interface is implemented in a client, wherein the server is coupled to the client via a data-bearing communication path.

25. A business information and decisioning control system according to claim 23, wherein the plurality of input mechanisms are configured to detect the user's input setting via tactile-related input detection, key actuation, sound recognition, motion detection, or biofeedback input detection.

26. A business information and decisioning control system according to claim 23, wherein the business system user interface includes:
a first display field for presenting information regarding what has happened in the business in the past;
a second display field for presenting information regarding what is presently happening in the business; and
a third display field for presenting information regarding what is projected to happen in the business in the future.

27. A business information and decisioning control system according to claim 23, wherein the user's selection of the input setting defines at least one of:
a setting pertaining to a number of assets involved in at least one of the interrelated business processes;
a setting pertaining to an amount of time that the assets are allocated to a task performed in at least one of the interrelated business processes; and
a setting pertaining to an amount of rework involved in revising a result provided by at least one of the interrelated business processes.

28. A business information and decisioning control system according to claim 23, wherein the predictive model is configured to generate the output result based, at least in part, on historical data collected from the interrelated business processes.

29. A business information and decisioning control system according to claim 28, further including an extract-transform-load module configured to collect the historical data from the interrelated business processes, transform the historical data into a designated form, and store the transformed data in a database for use by the business information and decisioning control system, wherein the database is coupled to the business information and decisioning control system.

30. A business information and decisioning control system according to claim 28, wherein the historical data is collected from at least one source that is internal to the business, and at least one source that is external to the business.

31. A business information and decisioning control system according to claim 23, wherein the predictive model is configured to generate the output result using a transfer function, wherein the transfer function maps at least one independent input variable to the output result.

32. A business information and decisioning control system according to claim 31, wherein at least one of the interrelated business processes can be modeled using the same transfer function used to provide the forecast in the control module.

33. A business information and decisioning control system according to claim 23, wherein the business information and decisioning control system includes a plurality of models, and wherein the control module further includes logic configured to automatically select a predictive model from the plurality of models based on an assessment performed by the business information and decisioning control system.

34. A business information and decisioning control system according to claim 23, wherein the output result pertains to at least one of:
a financial metric pertaining to a forecasted financial performance of the business;
a resource-related metric pertaining to resources used in the business or provided by the business; and
a cycle time pertaining to a time required to complete one or more tasks within the interrelated business processes.

35. A business information and decisioning control system according to claim 23, wherein the logic for presenting the output result is configured to display a visual representation of the output result to the user.

36. A business information and decisioning control system according to claim 35, wherein the logic for presenting the output result is configured to present the output result as an n-dimensional plot that maps the output result as a function of at least one independent variable.

37. A business information and decisioning control system according to claim 35, wherein the logic for presenting the output result is configured to present the output results as an n-dimensional plot that maps the output result as a function of time.

38. A business information and decisioning control system according to claim 35, wherein the logic for presenting the output result is configured to present the output result as a probabilistic response surface that provides an indication of a level of statistical confidence associated with the output result.

39. A business information and decisioning control system according to claim 35, the wherein the logic for presenting the output result is configured to dynamically update the output result in response to changes in at least one variable that has a bearing on the output result.

40. A business information and decisioning control system according to claim 35, wherein the logic for presenting the output result is configured to provide information regarding a measured result that reflects an actual course of the business for comparison with the output result.

41. A business information and decisioning control system according to claim 40, wherein the control module further includes logic configured to automatically compare the output result to the measured result based on at least one comparison factor.

42. A business information and decisioning control system according to claim 23, wherein the business pertains to a services-related business or a manufacturing business.

43. A computer-readable medium including instructions for carrying out the control module logic of claim 23.

44. A business system user interface of a business information and decisioning control system, wherein the business information and decisioning control system includes a control module that is configured to receive information provided by plural interrelated business processes in a business, and to provide commands to the interrelated business processes, comprising:
a first display field that presents a plurality of graphical input mechanisms; and
a second display field that presents an output result of a what-if forecast, wherein the input mechanisms are configured to:
receive a user's selection of an input setting, the input setting defining a what-if case scenario, wherein the control module is configured to generate the output result using a predictive model based on the what-if case scenario; and
receive the user's selection of a command, wherein the control module is configured to transmit instructions to at least one of the interrelated business processes based on the command, the instructions affecting a change in the at least one of the interrelated business processes representative of the input setting.

45. A business system, comprising:
multiple interrelated business processes for collectively accomplishing a business objective;
a business information and decisioning control system, including:
a control module configured to receive information provided by the interrelated business processes, and to provide commands to the interrelated business processes;
a business system user interface, coupled to the control module, configured to allow a user to interact with the control module, the business system user interface including plural input mechanisms for receiving instructions from the user;
wherein the control module includes:
logic configured to receive the user's selection of an input setting made using at least one of the plural input mechanisms, the input setting defining a what-if case scenario;
logic configured to perform a forecast based on the what-if case scenario to generate an output result using a predictive model, the output result forecasting an effect that the what-if case scenario will have on interrelated business processes;
logic configured to present the output result to the user; and
logic configured to receive the user's selection of a command via the business system user interface and to transmit instructions to at least one of the interrelated business processes based on the command, the instruction affecting a change representative of the input setting.

46. A method for performing and acting on what-if forecasts in a business that includes multiple interrelated business processes, comprising:
providing a business information and decisioning control system to a user, wherein the business information and decisioning control system is coupled to the interrelated business processes;
initiating an automated what-if analysis procedure performed using the business information and decisioning control system, the what-if analysis procedure including:
selecting an input setting that defines a what-if case scenario;
performing a forecast based on the what-if case scenario using a predictive model provided by the business information and decisioning control system to generate an output result, the output result forecasting an effect that the what-if case scenario will have on the interrelated business processes;
determining whether the output result is projected to provide a satisfactory effect on the interrelated business processes;
if the output result is determined to be unsatisfactory, repeating the selecting, performing, and determining until a satisfactory output result is achieved; and
if the output result is determined to be satisfactory, making a change to at least one of the interrelated business processes based on the input setting associated with the satisfactory output result.

47. A method according to claim 46, wherein the initiating is in response to manual activation by the user.

48. A method according to claim 46, wherein the initiating is in response to automatic triggering of the what-if analysis procedure in response to an occurrence of a predetermined event.

49. A method according to claim 46, wherein the determining of whether the output result is satisfactory includes comparing the output result to a predetermined business objective.

50. A business information and decisioning control system for performing and acting on what-if forecasts in a business that includes multiple interrelated business processes, comprising:
a control module configured to receive information provided by the interrelated business processes, and to provide commands to the interrelated business processes;
a business system user interface, coupled to the control module, configured to allow a user to interact with the control module;
wherein the control module includes automated business analysis logic including:
logic configured to initiate an automated what-if analysis procedure;
logic configured to select an input setting that defines a what-if case scenario upon initiation of the automated what-if analysis procedure;
logic configured to perform a forecast based on the what-if case scenario using a predictive model provided by the business information and decisioning control system to generate an output result, the output result forecasting an effect that the what-if case scenario will have on the interrelated business processes;
logic configured to determine whether the output result is projected to provide a satisfactory effect on the interrelated business processes;
wherein, if the output result is determined to be unsatisfactory, the automated business analysis logic is configured to repeat the selecting, performing, and determining performed by the logic for selecting, logic for performing, and logic for determining, respectively, until a satisfactory output result is achieved; and
wherein, if the output result is determined to be satisfactory, the business information and decisioning control system is configured to make a change to at least one of the interrelated business processes based on the input setting associated with the satisfactory output result.

51. A business information and decisioning system according to claim 50, wherein the logic for initiating is configured to initiate the what-if analysis procedure in response to manual activation by the user.

52. A business information and decisioning system according to claim 50, wherein automated business analysis logic for initiating is configured to initiate the what-if analysis procedure in response to an occurrence of a predetermined event.

53. A business information and decisioning system according to claim 50, wherein the logic for determining is configured to determine whether the output result is satisfactory by comparing the output result to a predetermined business objective.
